(19) United States
(12) Patent Application Publication
(10) Pub. No.: US 2006/0079624 A1
(43) Pub. Date: Apr. 13, 2006

(54) Crosslinkable polymer systems

(76) Inventors: Hildeberto Nava, Cary, NC (US); Aaron C. Small, Raleigh, NC (US)

Correspondence Address: MYERS BIGEL SIBLEY & SAJOVEC, PO BOX 37428, RALEIGH, NC, 27627, US

(21) Appl. No.: 10/961,862

(22) Filed: Oct. 8, 2004

(51) Int. Cl. B60C 1/00; C08K 3/40

(52) U.S. Cl. 524/492; 524/494

(57) ABSTRACT

The present invention provides a crosslinkable polymer system that can be crosslinked to form a wide variety of polymeric, copolymeric and oligomeric compounds. The crosslinkable system comprises (a) product Q formed from an aromatic ethylenically unsaturated moiety and a first reactive ethylenically unsaturated moiety, and (b) a second reactive ethylenically unsaturated moiety at least partially reacted with the first reactive ethylenically unsaturated moiety.

### FIELD OF THE INVENTION

The present invention relates to a crosslinkable polymer system, and more particularly to such a polymer system having carbon-carbon linkages in its backbone.

### BACKGROUND OF THE INVENTION

The thermosetting resin market generally comprises unsaturated polyesters, vinyl esters and urethane acrylates. Some disadvantages found in these types of resins are their hydrolytic, chemical, and thermal stabilities. Ester groups and urethane groups, common in unsaturated polyester resin (UPR) systems, are sensitive towards degradation or cleavage in hydrolytic and other chemical environments. Unsaturated polyesters which contain certain aromatic repeating units such as those based on terephthalate and/or isophthalate diacids, as well as saturated ring repeating units such as those based on cyclohexane diacids, in combination with diols such as neopentyl gycol and hexane diol, exhibit a certain improved level of hydrolytic and chemicals stability. However, highly enhanced hydrolytic stability or chemical stability cannot be achieved due to the presence of ester groups, and the reaction thereof under hydrolytic conditions (neutral, basic, and acidic) and many other chemical environments.

Another inherent problem with unsaturated polyesters is their shrinkage. Shrinkage with thermosetting resin systems can be as high as five percent, depending on unsaturated polyester alkyd reactivity and crosslinking monomer structure and level. Shrinkage usually occurs during the curing process and can affect the dimensional stability by warping of the finished parts. It is desirable to reduce the shrinkage and improve the surface appearance of the molded articles. The shrinkage problem can be alleviated by the addition of low profile additives such as thermoplastics. Often however, phase separation of the mixture arises due to incompatibility of the low profile additive(s) with the unsaturated polyester. Addition of expensive compatibilizers contributes to high price finished material and sometimes even this action is not guaranteed to prevent phase separation.

There are a large number of patents for molding compositions that describe the preparation of materials with low shrinkage and good physical properties. The patents describe compositions that include unsaturated polyesters, ethylenically unsaturated monomers and thermoplastic polymers used as low profile additives to control shrinkage. Typically, the molding compositions are processed at temperatures in the range of 100° to 150° C. Lower temperatures do not provide the desired mechanical properties, good surface profile and low shrinkage. Examples of molding compositions are described, for example, in U.S. Pat. No. 4,555,534, U.S. Pat. No. 4,172,059 and U.S. Pat. No. 5,296,544.

The thermoplastic polymers used as low profile additives to control shrinkage are described to have molecular weights in the range of 10,000 to about 250,000. The low profile additives may or may not include functional groups. For example, U.S. Pat. No. 4,555,534, U.S. Pat. No. 4,525,498 and U.S. Pat. No. 5,296,545 describe low profile additives having viscosities in the range of 4000 to 16,000 centipoises at 25° C. and dissolved in 50 to 60 percent concentration of an ethylenically unsaturated monomer such as styrene. The viscosities of such low profile additives are often too high to have an appropriate mixing. High viscosities also create difficulties in applications that require hand lay up and spray up.

U.S. Pat. No. 4,822,849, proposes reducing the shrinkage of the resin systems by reducing both the styrene level and unsaturation. Lower shrinkage is achieved without using a low profile additive, although the viscosities of the mixtures are in excess of 1400 centipoises making spray-up of the materials difficult.

U.S. Pat. No. 5,380,799 proposes the preparation of resin compositions moldable at room temperature comprising a thermosetting unsaturated polyester resin, a mixture of thermoplastic polymers of vinyl acetate, and accelerator, and a low temperature free radical peroxide initiator. Low shrink properties are obtained; however, using polyvinyl acetate thermoplastics as low profile additive has a side effect of too much water absorption deteriorating the physical properties of the products.

Chen-Chi Ma et al., describes in Polymer Engineering and Science, Vol. 43, page 989 (2003) that the curing rate of unsaturated polyester resins with a low profile additive decreases as the molecular weight of the low profile additive increases due to chain entanglements. High molecular weight low profile additives, such as polystyrene, however, are undesirable due to the increase in the viscosity of the mixtures. In addition, spraying ability of the resin is limited, and curing compromises final mechanical properties of the finished products.

An objective of the present invention is to prepare polymeric materials that have segments in their repeating units formed mainly by carbon-carbon linkages and that exhibit high hydrolytic, chemical, and thermal stability with little or no shrinkage in absence of any external low profile additives. There is a need for such materials being made with low viscosities that can be cured at room temperature, and have improved curing, good physical properties and low shrinkage.

### SUMMARY OF THE INVENTION

The present invention provides a crosslinkable polymer system that can be crosslinked to form a wide variety of polymeric, copolymeric and oligomeric compounds. The crosslinkable system comprises (a) product Q formed from an aromatic ethylenically unsaturated moiety and a first reactive ethylenically unsaturated moiety, and (b) a second reactive ethylenically unsaturated moiety at least partially reacted with the first reactive ethylenically unsaturated moiety. For purposes of this invention, the term “moiety” may include monomers, polymers and copolymers. The term “unsaturated” is intended to relate to the form of the moiety before any reaction.

The product Q provides carbon-carbon linkages as repeating units in the backbone of the polymer, copolymer or oligomer. The first and second ethylenically unsaturated moieties function both as solvents to carry out the polymerization and as reactive moieties to form the polymeric, copolymeric and/or oligomeric resins.

The product Q can also be combined with a variety of polymers to form mixtures with a wide variety of properties. Specifically, the product Q can be combined with a thermosettable moiety, a thermoplastic moiety, or a monomer which is crosslinkable with the reactive ethylenically unsaturated moiety of product Q.

In another embodiment, the crosslinkable polymer system comprises the product Q, a second reactive ethylenically unsaturated moiety at least partially reacted with the reactive ethylenically unsaturated moiety of product Q, and a thermosettable moiety, a thermoplastic moiety, or a monomer wherein the thermosettable moiety, thermoplastic moiety or monomer is crosslinkable with either the first or second reactive ethylenically unsaturated moiety or both.

### DETAILED DESCRIPTION OF THE PREFERRED EMBODIMENTS

The thermosetting resin market includes unsaturated polyesters, vinyl esters, and urethane acrylates. Some disadvantages found with these types of resins are their hydrolytic, chemical, and thermal stability. Ester groups and urethane groups are more sensitive to degradation or cleavage than are carbon-carbon bonds or linkages. In addition, a critical problem with thermosetting resin systems is shrinkage on curing. Shrinkage of thermosetting resins can be a few percent to as high as five percent, unacceptable levels for many applications. The objective of the present invention is to prepare polymer systems that are not only more stable to hydrolysis, but also have better thermal stability and are more easily processed.

Polymers with carbon-carbon linkages are more stable than esters and urethane linkages. For example, polymeric materials based on aromatic ethylenically unsaturated moieties and reactive ethylenically unsaturared moieties are prepared with reactive groups that undergo polymerization with reactive ethylenically unsaturared moieties. The crosslinked network has a reduced amount of ester groups compared to conventional polymer systems, resulting in a product more stable to hydrolysis and thermal degradation. Reactive ethylenically unsaturared materials containing functional groups such as hydroxyl, amino, epoxy, isocyanate, or other groups containing active hydrogens components can also be incorporated in the curing compositions to form crosslink networks containing such materials.

A variety of chemical procedures can be used for the preparation of the polymer materials of the present invention. Examples of these processes may include but are not limited to anionic polymerization, cationic polymerization, thermal polymerization, addition polymerization, metal catalyzed radical polymerization, radical polymerization using peroxides or azo type initiators, cobalt mediated polymerization, reversible addition-fragmentation transfer (RAFT) polymerization, radical polymerization using nitroxy-radicals, radical polymerization using diphenyl ethylene intermediates.

As summarized previously, the crosslinkable polymer system comprises a product Q formed from an aromatic ethylenically unsaturated moiety and a first reactive ethylenically unsaturated moiety wherein product Q provides carbon-carbon linkages in the backbone of said crosslinkable polymer system when crosslinked, and a second reactive ethylenically unsaturated moiety at least partially reacted with said first reactive ethylenically unsaturated moiety of product Q.

### Aromatic Ethylenically Unsaturated Moieties

Aromatic ethylenically unsaturated monomers that may be included as a diluent, reactant, co-reactant or may be post added once the polymerization of the desired polymer and/or oligomer was completed, and may include those such as, for example, styrene and styrene derivatives such as α-methyl styrene, p-methyl styrene, divinyl benzene, divinyl toluene, ethyl styrene, vinyl toluene, tert-butyl styrene, monochloro styrenes, dichloro styrenes, vinyl benzyl chloride, fluorostyrenes, tribromostyrenes, tetrabromostyrenes, and alkoxystyrenes (e.g., paramethoxy styrene). Other monomers which may be used include, 2-vinyl pyridine, 6-vinyl pyridine, 2-vinyl pyrrole, 2-vinyl pyrrole, 5-vinyl pyrrole, 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxozole, 3-vinyl isothiazole, 2-vinyl pyrimidine, 4-vinyl pyrimidine, 6-vinyl pyrimidine, and any vinyl pyrazine. Styrene and styrene derivatives are preferred.

### Reactive Ethylenically Unsaturared Moieties

1) Alkenes

In the present invention, any radically polymerizable alkene can serve as a first or second reactive moiety or monomer for polymerization. However, comonomers that correspond to the following formula are especially suitable for polymerization in accordance with the invention: 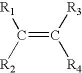
where R₁ and R₂ are independently selected from the group consisting of H, halogen, CN, straight or branched alkyl of from 1 to 20 carbon atoms, preferably 1 to 6, and more preferably 1 to 4 carbon atoms, which can be substituted with 1 to (2n+1) halogen atoms where n is the number of carbon atoms of the alkyl group (for example CF₃), α, β-unsubstituted straight or branched alkenyl or alkynyl groups with 2 to 10 carbon atoms, preferably 2 to 6 and specially preferably 2 to 4 carbon atoms which can be substituted with 1 to (2n−1) halogen atoms where n is the number of carbon atoms of the alkyl group, α,β-unsaturated straight or branched of 2 to 6 carbon atoms (preferably vinyl) substituted (preferably at the α-position) with a halogen (prefereably chlorine), C₃-C₈ cycloalkyl, heterocyclyl, C(═Y)R₅, C(═Y)NR₆R₇, YC (═Y)R₅, SOR₅, SO₂R₅, OSO₂R₅, NR₈SO₂R₅, PR₅², P(═Y)R₅², YPR₅², YP(═Y) R₅², NR₈², which can be quaternized with an additional R₈, aryl, or heterocyclyl group, where Y may be NR₈, S or O, preferable O; R₅ is alkyl of from 1 to 20 carbon atoms, an alkylthio group with 1 to 20 carbon atoms, OR₁₅ (R₁₅ is hydrogen or an alkyl metal), alkoxy of from 1 to 20 carbon atoms, aryloxy or heterocyclyloxy; R₆ and R₇ are independently H or alkyl of from 1 to 20 carbon atoms, or R₆ and R₇ may be joined together to form an alkylene group of from 2 to 7 carbon atoms, preferably 2 to 5 carbon atoms, where they form a 3- to 8-member ring, preferably 3 to 6 member ring, and R₈ is H, straight or branched C₁-C₂₀ alkyl or aryl; and R₃ and R₄ are independently selected from the group consisting of H, halogen (preferably chlorine or fluorine), C₁-C₆ alkyl or COOR₉, where R₉ is H, an alkyl metal, or a C₁-C₄₀ alkyl group; or R₁ and R₃ can together form a group of the formula (CH₂)ₙ; which can be substituted with 1 to 2n halogen atoms or a group of the formula C(═O)—Y—C(═O), where n is from 2 to 6, preferably 3 to 4, and Y is defined as before; and where at least two of R₁, R₂, R₃ and R₄ are H or halogen.

Furthermore in the present application, “aryl” refers to phenyl, naphthyl, phenanthryl, anthracenyl, phenalenyl, tripehnylenyl, fluoranthrenyl, pyrenyl, pentacenyl, chrycenyl, naphthacenyl, hexaphenyl, picenyl and perynelenyl (preferably phenyl and naphthyl), in which each hydrogen atom may be replaced with alkyl of from 1 to 20 carbon atoms (preferably from 1 to 6 carbon atoms and more preferably methyl) alkyl of from 1 to 20 carbon atoms (preferably from 1 to 6 carbon atoms and more preferably methyl) in which each of the hydrogen atoms is independently replaced by a halide (preferably a fluoride or a chloride), alkenyl of from 2 to 20 carbon atoms, alkynyl of from 1 to 20 carbon atoms, alkoxy from 1 to 6 carbon atoms, alkylthio of from 1 to 6 carbon atoms, C₃-C₈ cycloalkyl, phenyl, halogen, NH₂, C₁-C₆-alkylamino, C₁-C₆ dialkylamino, and phenyl which may be substituted with the from 1 to 5 halogen atoms and/or C₁-C₄ alkyl groups. (This definition of “aryl” also applies to the aryl groups in “aryloxy” and “aralkyl”). Thus phenyl may be substituted from 1 to 5 times and naphthyl may be substituted from 1 to 7 times (preferably, any aryl group, if substituted, is substituted from 1 to 3 times) with one of the above substituents. More preferably, “aryl” refers to phenyl, naphthyl, phenyl substituted from 1 to 5 times with fluorine or chlorine, and phenyl substituted from 1 to 3 times with a substituent selected from the group selected from the group consisting of alkyl of from 1 to 6 carbon atoms, alkoxy of from 1 to 4 carbon atoms and phenyl. Most preferably, “aryl” refers to phenyl, tolyl and methoxyphenyl. Preferred substituents include amines, substituted phosphorus, sylyl, siloxy, epoxy, isocyanate and hydroxyl.

In the context of the present invention, “heterocyclyl” refers to pyrydyl furyl, pyrrolyl, furyl, pyrrolyl, thienyl, imidazolyl, pyrazolyl, pyrazinyl, pyridiminyl, pyridazinyl, pyranyl, indonyl, isoindonyl, indazolyl, benzofuryl, isobenzofuryl, benzothienyl, isobenzothienyl, chromenyl, xanthenyl, purinyl, pteridinyl, quinolyl, isoquinolyl, phthalazinyl, quinazolinyl, quinoxalinyl, naphthyridinyl, phenoxathiinyl, carbazolyl, cinnolinyl, phenanthridinyl, acridinyl, 1,10-phenanthrolinyl, phenazinyl, phenoxazinyl, phenothiazinyl, oxazolyl, thiazolyl, isoxaloyl, and hydrogenated forms thereof known to those in the art. Preferred hetrerocyclyl groups include imidazolyl, pyrazolyl, pyrazinyl, pyridyl, furyl, pyrrolyl, thienyl, pyrimidinyl, pyridazinyl, pyranyl, and indolyl.

Classes of other reactive unsaturated moieties or monomers also include, but are not limited to, (meth)acrylates, vinyl aromatic monomers, vinyl halides and vinyl esters of carboxylic acids. As is used herein and in the claims, by “(meth)acrylate” and the like terms is meant both (meth)acrylates and acrylates. Examples include but are not limited to oxyranyl (meth)acrylates like 2,3-epoxybutyl (meth)acrylate, 3,4-epoxybutyl (meth)acrylate, 10,11 epoxyundecyl (meth)acrylate, 2,3-epoxycyclohexyl (meth)acrylate, glycidyl (meth)acrylate, hydroxyalkyl (meth) acrylates like 3-hydroxypropyl (meth)acrylate, 2,5-dimethyl-1,6-hexanediol (meth)acrylate, 1,10-decanediol (meth)acrylate, aminoalkyl (meth)acrylates like N-(3-dimethylaminopentyl (meth)acrylate, 3-dibutylaminohexadecyl (meth)acrylate; nitriles of (meth)acrylic acid and other nitrogen containing (meth)acrylates like N-((meth)acryloyloxyethyl)diisobutylketimine, N-((meth)acryloylethoxyethyl)dihexadecylketimine, (meth)acryloylamidoacetonitrile, 2-(meth)acryloxyethylmethylcyanamide, cyanoethyl (meth)acrylate, aryl (meth)acrylates like benzyl (meth)acrylate or phenyl (meth)acrylate, where the acryl residue in each case can be unsubstitute or substituted up to four times; carbonyl-containing (meth)acrylates like 2-carboxyethyl (meth)acrylate, carboxymethyl (meth)acrylate, oxazolidinylethyl (meth)acrylate, N-((meth)acryloyloxy) formamide, acetonyl (meth)acrylate, N-(meth)acryloylmorpholine, N-(meth)acryloyl-2-pyrrolidinone, N-(2-(meth)acryloxyoxyethyl)-2-pyrrolidinone, N-(3-(meth)acryloyloxypropyl)-2-pyrrolidinone, N-(2-(meth)acryloyloxypentadecenyl)-2-pyrrolidinone, N-(3-(meth)acryloyloxyheptadecenyl)-2-pyrrolidinone; (meth)acrylates of ether alcohols like tetrahydrofurfuryl (meth)acrylate, vinyloxyethoxyethyl (meth)acrylate, methoxyethoxyethyl (meth)acrylate, 1-butoxypropyl (meth)acrylate, 1-methyl-(2-vinyloxy)ethyl (meth)acrylate, cyclohexyloxymethyl (meth)acrylate, methoxymethoxyethyl (meth)acrylate, bezyloxymethyl (meth)acrylate, furfuryl (meth)acrylate, 2-butoxyethyl (meth)acrylate, 2-ethoxyethoxymethyl (meth)acrylate, 2-ethoxyethyl (meth)acrylate, allyloxymethyl (meth)acrylate, 1-ethoxybutyl (meth)acrylate, ethoxymethyl(meth)acrylate; (meth)acrylates of halogenated alcohols, like 2,3-dibromopropyl (meth)acrylate, 4-bromophenyl (meth)acrylate1,3-dichloro-2-propyl (meth)acrylate, 2-bromoethyl (meth)acrylate, 2-iodoethyl (meth)acrylate, chloromethyl (meth)acrylate, 2-isocyanatoethyl methacrylate, vinyl isocyanate, 2-acetoacetoxyethyl methacrylate; phosphorus-, boron, and/or silicon-containing (meth)acrylates like 2-(dimethylphosphato)propyl (meth)acrylate, 2-(ethylphosphito)propyl (meth)acrylate, dimethylphosphinoethyl (meth)acrylate, dimethylphosphinomethyl (meth)acrylate, dimethylphosphonoethyl (meth)acrylate, dimethyl(meth)acryloyl phosphonate, dipropyl(meth)acryloyl phosphate, 2-(dibutylphosphono)ethyl methacrylate, 2,3-butelene(meth)acryloylethyl borate, methyldiethoxy(meth)acryloylethoxysilane, diethylphosphatoethyl (meth)acrylate; sulfur-containing (meth)acrylates like ethylsulfinylethyl (meth)acrylate, 4-thiocyanatobutyl (meth)acrylate, ethylsulfonylethyl (meth)acrylate, thiocyanathomethyl (meth)acrylate, methylsulfonylmethyl (meth)acrylate, bis((meth)acryloyloxyethyl) sulfide.

2) Polyfunctional Monomers

Polyfunctional acrylates may be used in the resin composition, including those described, for example, in U.S. Pat. No. 5,925,409 to Nava, the disclosure of which is incorporated by reference herein in its entirety. Such compounds include, but are not limited to, ethylene glycol (EG) dimethacrylate, butanediol demethacrylate, and the like. The polyfunctional acrylate which may be used in the present invention can be represented by the general formula: 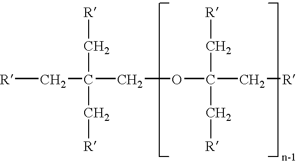
wherein at least four of the represented R′ groups present are (meth)acryloxy groups, with the remainder of the R′ groups being an organic group except (meth)acryloxy groups, and n is an integer from 1 to 5. Examples of polyfunctional acrylates include ethoxylated trimethyolpropane triacrylate, trimethyolpropane tri(meth)acrylate, trimethyolpropane triacrylate, trimethylolmethane tetra(meth)acrylate, pentaerythritol tetra(meth)acrylate, dipentaerythritol tetra(meth) acrylate, dipentaerythritol penta(meth)acrylate, and dipentaerythritol hexa(meth)acrylate; hetorocyclic (meth)acrylates like 2-(1-imidazolyl)ethyl (meth)acrylate, 2-(4-morpholyl)ethyl (meth)acrylate and 1-(2-(meth)acryloyloxyethyl)-2-pyrrolidinone; vinylhalides such as vinyl chloride, vinyl fluoride, vinylidene chloride and vinylidene fluoride; vinyl esters like vinyl acetate, vinyl butyrate, vinyl 3,4-dimethoxybenzoate, vinyl benzoate and isoprenyl esters; crotonic acid, itaconic acid or anhydride, maleic acid and maleic acid derivatives such as mono and diesters of maleic acid, maleic anhydride, methyl maliec anhydride, methylmaleimide; fumaric and fumaric acid derivatives such as mono and diesters of fumaric acid.
3) Olefins

As use herein and in the claims, the term “olefin” is meant to denote unsaturated aliphatic hydrocarbons having one or more double bonds, obtained by cracking petroleum fractions. Specific examples of olefins may include, but are not limited to, propylene, 1-butene, 1,3-butadiene, isobutylene and di-isobutylene.

As used herin and in the claims, by “(meth)allylic monomer(s)” is meant monomers containing substituted and/or unsubstituted allylic functionality, i.e., one or more radicals represented by the following general formula:
H₂C═C(Z)-CH₂—

Wherein Z is a hydrogen, halogen or a C₁ to C₄ alkyl group. Most commonly, Z is a hydrogen or a methyl group, but are not limited to; (meth)allyl alcohol; (meth)allyl ethers, such as methyl (meth)allyl ether, (meth)allyl esters of carboxylic acids, such as (meth)allyl acetate, (meth)allyl benzoate, (meth)allyl n-butyrate, (meth)allyl esters of VERSATIC acid, and the like.

The components can be used individually or as mixtures. These components can be added to a reaction mixture at the same time or sequentially in order to obtain copolymers in accordance with the invention. Statistical copolymers, gradient copolymers, graft copolymers, random copolymers and block copolymers result, in each case according to the type of addition. For the purpose of this disclosure, the term “polymerization”, “cure” or “curing” means the transformation of the resins systems from liquid to gel or solid state. The curing occurs during the crosslinking process of the reactive sites of the resin(s) and the ethylenical unsaturation of the monomers containing the resin(s). Depending on the catalyst system used, curing can optionally occur at temperatures from about 5° C. to about 150° C. for a time of 30 seconds to about 24 hours.

A large number of mixtures, which all contain monomers that are to be polymerized, can be used to obtain the desired compositions of the polymers, copolymers and oligomers. Also, continuous or batch wise mixtures of the monomer mixtures is conceivable, where their compositions are in general kept constant over the period of the addition in order to ensure a statistical distribution of the individual structural units in the copolymer. Besides statistical copolymers, gradient and block copolymers can be obtained by the method of this invention by varying the composition of monomers, thus the relative concentration of the two moieties to each other during the polymerization.

Random copolymers can be also obtained by adding mixtures of monomers during the polymerization. The monomers in the reaction mixture may function as the solvent medium and reactant. Additional monomers may be post added once the desired molecular weight and conversion in the polymerization mixture was reached.

In order to form product Q, the aromatic ethylenically unsaturated moiet(ies) and the ethylenically unsaturated moiet(ies) are combined in the presence of an initiator, catalyst polymerization liquids, inhibitors, chemical transfer agents, solvents, and the like. Such compounds are selected in accordance with the properties desired. The polymerization can be carried out at normal pressure, reduce pressure or elevated pressure. The polymerization temperature in general it lies in the range of −20° to 200° C., preferably 0°-130° C., and especially preferably 60°-120° C., without limitation intended by this.

### Polymerization Initiators

Initiators that can be used in accordance with the invention can be any compound that has one or more atoms or atomic groups that are radically transferable under the polymerization conditions.

Suitable initiators include those of the formulas:
R₁₁R₁₂R₁₃C—X
R₁₁C(═O)—X
R₁₁R₁₂R₁₃Si—X
R₁₁R₁₂N—X
R₁₁N—X₂
(R₁₁)ₙP(O)ₘ—X₃₋ₙ
(R₁₁O)ₙP(O)ₘ—X₃₋ₙ and
(R₁₁)(R₁₂O)P(O)ₘ—X,
where X is selected from group consisting of Cl, Br, I, OR₁₀, [where R₁₀ is an alkyl group with 1 to 10 carbon atoms, where each hydrogen atom can be independently be placed by a halide, preferably chloride or fluoride, an alkenyl with 2 to 20 carbon atoms, preferably vinyl, an alkynyl with 2 to 10 carbon atoms, preferably acetylenyl or phenyl, which can be substituted with 1 to 5 halogen atoms or alkyl groups with 1 to 4 carbon atoms, or aralkyl or alkyl groups with 1 to 4 carbon atoms, or aralkyl (aryl-substituted alkyl alkyl in which the aryl group is phenyl or substituted phenyl and the alkyl group is an alkyl with 1 to 6 carbon atoms, such as benzyl, for example)], SR₁₄, SeR₁₄, OC(═O)R₁₄, OP(═O)R₁₄, OP(═O)(OR₁₄)₂, OP(═O)OR₁₄, O—N(R₁₄)₂, S—C(═S)N(R₁₄)₂, CN, NC, SCN, CNS, OCN, CNO and N₃, where R₁₄ means an alkyl group or a linear or branch alkyl group with 1 to 20, preferably 1 to 10 carbon atoms, where two R₁₄ groups, if present, together can form a 5, 6, or 7-member heterocyclic ring; and R₁₁, R₁₂ and R₁₃ are independently chosen from the group consisting of hydrogen, halogens, alkyl groups with 1 to 20, preferably 1 to 10 and specially 1 to 6 carbon atoms, cycloalkyl groups with 3 to 8 carbon atoms, (R₈)₃Si, C(═Y)R₅, C(═Y)NR₆R₇, where Y, R₅, R₆ and R₇ are defined as above, COCl, OH, (preferably one of the residues R₁₁, R₁₂ and R₁₃ is OH), CN, alkenyl or alkynyl groups with 2 to 20 carbon atoms, preferably 2 to 6 carbon atoms and specially preferably allyl or vinyl, oxiranyl, glycidyl, alkylene or alkenylene groups with 2 to 6 carbon atoms, which are substituted with oxiranyl or glycidyl, aryl, heterocyclyl, aralkyl, aralkenyl (aryl-substituted alkenyl, where aryl is defined as above and alkenyl is vinyl, which is substituted with one or two C₁ to C₆ alkyl groups and/or halogen atoms, preferably with chlorine), alkyl groups with 1 to 6 carbon atoms, in which one up to all of the hydrogen atoms, preferably one, is/are substituted by halogen (preferably fluorine or chlorine, if one or more hydrogen atoms are replaced, and preferably fluorine, chlorine or bromine, if one hydrogen atom is replaced), alkyl groups with 1 to 6 carbon atoms, which with 1 to 3 substituents (preferably 1) are chosen from the group consisting of C₁-C₄ alkoxy, aryl, heterocyclyl, C(═Y)R₅, (where R₅ is defined as above), C(═Y)NR₆R₇ (where R₆ and R₇ are defined as above), oxiranyl and glycidyl (preferably not more than 2 of the residues R₁₁, R₁₂ and R₁₃ are hydrogen, especially preferably a maximum of one of the residues R₁₁, R₁₂ and R₁₃ is hydrogen); m is 0 to 1; and n is 0, 1 or 2.

Among the specially preferred initiators are benzyl halides like p-chloromethyl styrene, α-dichloroxylene, α,α-dichloroxylene, α,α-dibromoxylene and hexakis(α-bromomethyl)benzene, benzyl chloride, benzyl bromide, 1-bromo-1-phenylethane and 1-chloro-1-phenylethane; carboxylic acids derivatives that are halogenated in alfa position, such as propyl 2-bromopropionate, methyl 2-chloropropionate, ethyl 2-chloropropionate, methyl 2-bromopropionate, ethyl 2-bromoisobutyrate, tosyl halides such as p-toluenesulfonyl chloride; alkyl halides like tetrachloromethane, tribromomethane, 1-vinylethyl chloride, 1-vinylethyl bromide, 1-vinylethyl bromide; and halogen derivatives of phosphoric acid esters like dimethyl phosphoric chloride. Additional useful initiators and the various radically transferable groups that may be associated with them are described in WO 97/47661, the disclosure of which is incorporated by reference.

Polymeric compounds (including oligomeric compounds) having radical transferable groups may be used as initiators, and are herein referred as “macroinitiators.” Examples of macroinitiators include, but are not limited to, polystyrene prepared by cationic polymerization and having a terminal halide, e.g., chloride, (chloromethyl) polystyrene prepared by radical polymerization, (chloromethyl) polystyrene co-polystyrene prepared by radical polymerization, a polymer of 2-(2-bromopropionoxy) ethyl acrylate and one or more alkyl (meth)acrylates, e.g., butyl acrylate, prepared by conventional non-living radical polymerization. Macroinitiators can be used to prepared graft polymers, such as grafted block compolymers and comb compolymers. A further discussion af macroinitiators is found in U.S. Pat. No. 5,789,487, the disclosure of which is incorporated by reference in its entirety.
The initiator may include: 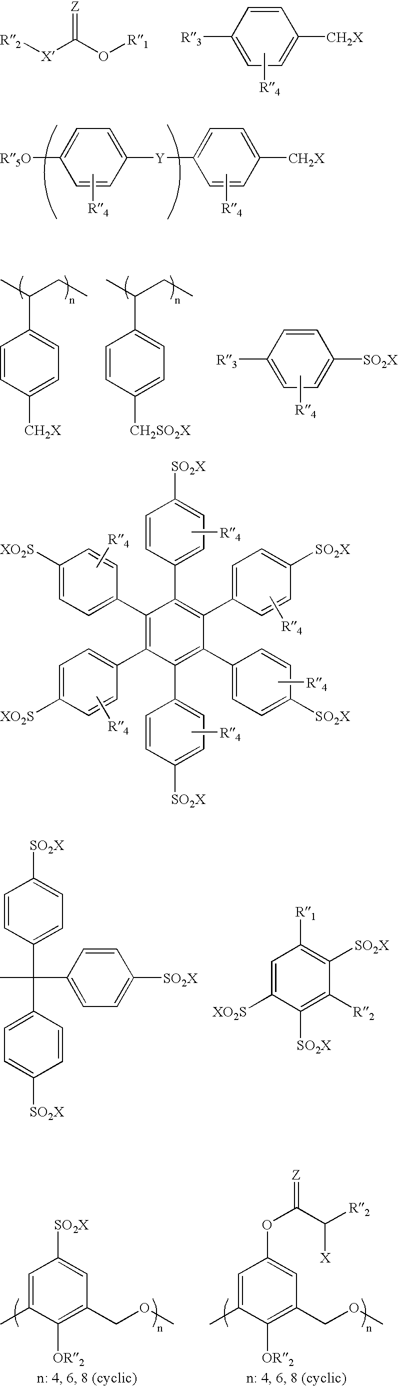
Where: R″₁, is a H, C₁ to C₂₀ hydrocarbon chain that may be linear or branch and may contain 1 to 5 hydroxy, thiol or amino groups, or a combination of them.
R″₂ is a H, C₁ to C₂₀ hydrocarbon chain that may be linear or branch and may contain 1 to 5 hydroxy, thiol or amino groups, or a combination of them.
R″₃ is a H, OH, COOR₁, SH, SO₂X, NHR₁, NH₂, R″₁P(O), C₁ to C₂₀ hydrocarbon chain that may be linear or branch and may contain 1 to 5 hydroxy, thiol or amino groups, or a combination of them.
R″₄ is a Br, Cl, F, I, H, OH, SH, SO₂X, R″₁P(O), C₁ to C₂₀ hydrocarbon chain that may be linear or branch and may contain 1 to 5 hydroxy, thiol or amino groups, or a combination of them.
R″₅ is a H, R″₁P(O), C₁ to C₂₀ hydrocarbon chain that may be linear or branch and may contain 1 to 5 hydroxy, thiol or amino groups, or a combination of them.
X is a Br, Cl, I
Y is a O, C(O), COO, S, S(O), SO₂, NH, CH₂, R″₁P(O).

Preferably, the initiator may be selected from the group consisting of halomethane, methylenedihalide, haloform, carbon tetrachloride, methanesulfonyl halide, p-toluenesulfonyl halide, methanesulfenyl halide, p-toluenesulfenyl halide, 1-phenylethyl halide, 2-halopropionitrile, C₁-C₆-alkyl ester of 2-halo-C₁-C₆-carboxylic acid, p-halomethyl styrene, mono-hexakis (α-halo-C₁-C₆-alkyl)benzene, diethyl-2-halo-2methyl malonate, benzyl halide, ethyl 2-bromoisobutyrate and mixtures thereof.

Additional useful initiators and the various radically transferable groups that may be associated with them are described in international patent publication WO 96/30421, the disclosure of which is incorporated by reference herein in its entirety.

The initiator is in general used in a concentration in the range of 10⁻⁴ mol/L to 3 mol/L, preferably in the range of 10⁻³ mol/L to 10⁻¹ mol/L and especially preferably in the range of 5×10⁻² mol/L to 5×10⁻¹ mol/L, without any limitations included by this. The molecular weight of the polymer results from the ratio of the initiator to monomer, if all the monomer is converted. Preferably this ratio lies in the range of 10⁻⁴ to 1 up to 0.5 to 1, especially in the range of 5×10⁻³ to 1 up to 5×10⁻² to 1.

### Polymerization Catalysts

Catalysts that contain at least one transition metal are used to conduct the polymerization. Here any transition metal compound that can produce a redox cycle with the initiator or the polymer chain that has a transferable atomic group can be used. In these cycles the transferable atomic group and the catalyst reversibly form a compound, with the degree of oxidation of the transition metal being increased or decreased. Here one assumes that the radicals are released or trapped, so that the concentration of radicals stays very low. Preferred transition metal compounds are those which do not form a direct carbon-metal bond with the polymer chain. Particularly suitable transition metal compounds are those of the formula Mⁿ⁺X′ where: Mⁿ⁺ may be for example, selected from the group consisting of Cu¹⁺, Cu²⁺, Au⁺, Au²⁺, Au³⁺, Ag⁺, Ag²⁺, Hg⁺, Hg²⁺, Ni⁰, Ni⁺, Ni²⁺, Ni³⁺, Pd⁰, Pd⁺, Pd²⁺, Pt⁰, Pt⁺, Pt²⁺, Pt³⁺, Pt⁴⁺, Rh⁺, Rh²⁺, Rh³⁺, Rh⁴⁺, Co⁺, C²⁺, C³⁺, Ir⁰, Ir⁺, Ir²⁺, Ir³⁺, Ir⁴⁺, Fe²⁺, Fe³⁺, Ru²⁺, Ru³⁺, Ru⁴⁺, Ru⁵⁺, Ru⁶⁺, Os²⁺, Os³⁺, Os⁴⁺, Re²⁺, Re³⁺, Re⁴⁺, Re⁶⁺, Re⁷⁺, Mn³⁺, M⁴⁺, Cr²⁺, Cr³⁺, Mo⁰, Mo⁺, Mo²⁺, Mo³⁺, W²⁺, W³⁺, V²⁺, V³⁺, V⁴⁺, V⁵⁺, Nb²⁺, Nb³⁺, Nb⁴⁺, Nb⁵⁺, Ta³⁺, Ta⁴⁺, Ta⁵⁺, Zn⁺ and Zn²⁺; X′ may be, for example, selected from the group consisting of halogen, OH, (O)_{1/2}, C₁-C₆-alkoxy, (SO₄)_{1/2}, (PO₄)_{1/3}, (HPO₄)_{1/2}, (H₂PO₄), triflate, hexafluoroborate, methane sulfonate, arylsulfonate (preferably benzensulfonate or toluenesulfonate), SeR₁₄, CN, NC, SCN, CNS, OCN, CNO, N₃ and R₁₅COO₂, where R₁₄ is defined above and R₁₅ is H or a straight or branched C₁-C₆ alkyl group (preferably methyl) or aryl (preferably phenyl) which may be substituted from 1 to 5 times with a halogen (preferably 1 to 3 times with fluorine or chlorine); and N is the formal charge on the metal (e.g., 0≦n≧7). Among the preferred metallic compounds are Cu₂O, CuBr, CuCl, CuI, CuN₃, CuSCN, CuCN, CuNO₂, CuNO₃, CUBF₄, Cu(CH₃COO), Cu(CF₃COO), FeBr₂, RuBr₂, CrCl₂, and NiBr₂.

However, compounds in higher oxidation states can also be used, for example CuO, CuBr₂, CuCl₂, CrCl₃, Fe₂O₃, and FeBr₃. In these cases the reaction can be initiated with the aid of classical radical formers such as AIBN. Here the transition metal compounds are reduced at first, since they are reacted with the radicals generated from the classical radical formers. This approach is described by Wang in Macromolecules Vol. 28, pp. 7572-7573 (1995).

Moreover, the transition metals can be used for catalysis a metal in the zero oxidation state, especially in mixtures with the previously mentioned compounds, as is indicated, for example, in WO 98/40415. In these cases the reaction rate of the conversion can be increased. One assumes that in this way the concentration of the catalytically active transition metal compound is increased by co-proportionating transition metals in a high oxidation state with metallic transition metal.

The molar ratio of transition metal to initiator lies in general in the range of 0.0001:1 to 10:1, preferably in the range of 0.001:1 to 5:1 and especially preferably in the range of 0.01:1 to 2:1, without this intending to imply any limitation.

### Polymerization Ligands

The polymerization takes place in the presence of ligands that can form a coordination compound with the metallic catalyst(s). These ligands serve, among other things, to increase the solubility of the transition metal compound. Another important function of the ligands is that the formation of stable organometallic compounds is avoided. This is particularly important, since these stable compounds would not polymerize under the selected reaction conditions. In addition, it is assumed that the ligands facilitate the abstraction of the transferable atomic group.

These ligands are substantially known and are described, for example, in WO 97/18247, WO 98/40415 and U.S. Pat. No. 5,807,937, the disclosure of which are incorporated by reference in their entirety. These compounds in general have one or more nitrogen, oxygen, phosphorus and/or sulfur atoms, by which the metal atom can be bonded. Many of these ligands can in general be represented by the formula R₁₆-Z-R₁₇ or R₁₆-Z-(R₁₈-Z)ₘ—R₁₇, where: R₁₆ and R₁₇ independently mean H, C₁ to C₂₀ alkyl, aryl, heterocyclyl, which can optionally be substituted. These substituents include, among others, alkoxy residues and alkylamino residues. R₁₆ and R₁₇ can optionally form a saturated, unsaturated or heterocyclic ring. Z means O, S, NH, NR₁₉, or PR₁₉, where R₁₉ has the same meaning as R₁₆. R₁₈ means, independently, a divalent group with 1 to 40 carbon atoms, preferably 2 to 4 carbon atoms, which can be linear, branched or cyclic, such as methylene, ethylene, propylene or butylenes. The meaning of alkyl and aryl were given above. Heterocyclyl residues are cyclic residues with 4 to 12 carbon atoms, in which one or more of the CH₂ groups of the ring has been replaced by heteroatom groups like), S, NH and/or NR, where the residue R has the same meaning as R₁₆.

Another group of suitable ligands can be represented by the formula 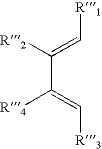
where R′″₁, R′″₂, R′″₃ and R′″₄ independently mean H, C₁-C₂₀, alkyl, aryl, heterocyclyl and/or heteroaryl residues, where the residue R′″₁ and R′″₂ or R′″₃ and R′″₄ together can form a saturated ring. Preferred ligands are chelate ligands that contain N atoms.

Among the preferred ligands are triphenylphosphane, 2,2-bipyridine, alkyl-2,-bipyridine like 4,4-di-(5-nonyl)-2,2-bipyridine, 4,4-di-(5-heptyl)-2,2-bipyridine, tris(2-aminoethyl)amine (TREN), N,N,N′,N′,N″-pentamethyldiethylenetriamine, 1,14,7,10,10-hexamethyltriethylenetetraamine and/or tetramethylethylenediamine. Other preferred ligands are described, for example, in WO 97/47661 and U.S. Pat. No. 6,407,187 B1. The ligands can be used individually or as a mixture. The ligands can form coordination compounds in situ with the metal compounds or they can be prepared initially as coordination compounds and then added to the reaction mixture.

The ratio of ligand to transition metal is dependent upon the dentation of the ligand and the coordination number of the transition metal. In general the molar ratio is in the range of 100:1 to 0.1:1, preferably 6:1 to 0.1:1 and especially preferably 3:1 to 0.5:1, without this intending to imply any limitation.

The monomers, the transition metal catalysts, the ligands and the initiators are chosen in each case according to the desired polymer solution.

### Polymerizations Solvents

The polymerization is typically carried out in a solvent. The term solvent is to be broadly understood here. The solvents include the same ethylenically unsaturated monomers used during the polymerization allowing their reaction conversion in general in the range of 20 to 99 percent, preferably from 30 to 90 percent and especially preferably from 50 to 80 percent, without this intending to imply any limitation. Preferred monomers used as solvents and reactants include styrene, methyl methacrylate and butyl acrylate and may be use in a range of 1 to 99 percent as a mixture.

Other solvents that may be used are nonpolar solvents. Among these solvents are hydrocarbon solvents such as aromatic solvents like toluene, benzene and xylene, saturated hydrocarbons such as cyclohexane, heptane, octane, nonane, decane, dodecane, which can also occur in branch form. These solvents can be used individually and as a mixture. The nonpolar solvents may be used in the ranges from 0 to 50 percent, preferably 0 to 20 percent and especially preferably 0 to 5 percent, without this intending to imply any limitation. The skilled artisan will find valuable advice for choosing these and other solvents in U.S. Pat. No. 6,391,996 B1, the disclosure of which is incorporated by reference in its entirety.

The polymers prepared in this way in general have a molecular weight in the range of 400 to 80,000 g/mol, preferably in the range of 600 to 50,000 g/mol, and especially preferably from 1,000 to 40,000 g/mol, without any limitations intended by this. These values refer to the weight average molecular weight of the polydisperse polymers in the composition.

### Polymerization Inhibitors

Polymerization inhibitors may also be included in the polymerization mixture such as phenol, 2,6-di-tert-butyl-4-methyl phenol, hydroquinone (HQ), tolu-hydroquinone (THQ), bisphenol “A” (BPA), naphthoquinone (NQ), p-benzoquinone (p-BQ), butylated hydroxy toluene (BHT), hydroquinone monomethyl ether (HQMME), 4-ethoxyphenol, 4-propoxyphenol, and propyl isomers thereof, monotertiary butyl hydroquinone (MTBHQ), ditertiary butyl hydroquinone (DTBHQ), tertiary butyl catechol (TBC), 1,2-dihydroxybenzene, 2,5-dichlorohydroquinone, 2-acetylhydroquinone, 1,4-dimercaptobenzene, 4-aminophenol, 2,3,5-trimethylhydroquinone, 2-aminophenol, 2-N,N,-dimethylaminophenol, catechol, 2,3-dihrydroxyacetrophenone, pyrogallol, 2-methylthiophenol. Other substituted and unsubstituted phenols and mixtures of the above.

Other polymerization inhibitors include stable hindered nitroxyl compounds having the structural formula: 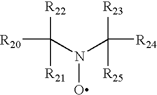
where R₂₀, R₂₁, R₂₅ and R₂₄ are the same or different straight chain or branch substituted or unsubstituted alkyl groups of a chain length. R₂₃ and R₂₄ are independently selected from the group consisting of halogen, cyano, COOR₂₀, —S—COR₂₀, —OCOR₂₀, amido, —S—C₆H₅, carbonyl, alkenyl, or alkyl of 1 to 15 carbon atoms, or may be part of a cyclic structure which may be fused with it another saturated or aromatic ring.

In a particular preferred embodiment, the stable hindered nitroxyl compound has the structural formula: 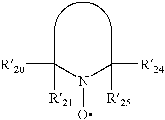
where R′₂₀ and R′₂₄ are independently selected from the group consisting of hydrogen, alkyl, and heteroatom-substituted alkyl and R′₂₁ and R′₂₅, are independently selected from the group consisting of alkyl heteroatom-substituted alkyl, and the [symbol]
portion represents the atoms necessary to form a five-, six-, or seven member ring heterocyclic ring.

Accordingly one of the several classes of cyclic nitroxides that can be employed in the practice of the present invention can be presented by the following structural formula: 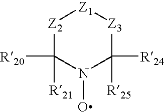
wherein Z₁, Z₂ and Z₃ are independently selected from the group consisting of oxygen, sulfur, secondary amines, tertiary amines, phosphorus of various oxidation states, and substituted and unsubstituted carbon atoms, such as >CH₂, >CHCH₃, >C═O, >C(CH₃)₂, >CHBr, >CHCl, >CHI, >CHF, >CHOH, >CHCN, >CH(OH)CN, >CHCOOH, >CHCOOCH₃, >CHC₂H₅, >C(OH)COOC₂H₅, >C(OH)COOCH₃, >C(OH)CH(OH)C₂H₅, >CR′₂₀OR′₂₁, >CHNR′₂₀R′₂₁, >CCONR′₂₀R′₂₁, >C═NOH, >C═CH—C₆H₅, >CF₂, >CCl₂, >CBr₂, >Cl₂, and the like. Additional useful stable hindered nitrxyl inhibitors are described on patent publications WO 01/40404 A1, WO01/40149 A2, WO 01/42313 A1, U.S. Pat. No. 4,141,883, U.S. Pat. No. 6,200,460 B1, U.S. Pat. No. 5,728,872, the disclosures of which are incorporated herein in their entirety. Cyclic nitroxides may also function as initiators in the presence of peroxide radicals and can also be used as such in the present invention.

Other inhibitors that may be used include oxime compounds of the following formula: 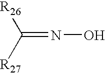
where R₂₆ and R₂₇ are the same or different and are hydrogen, alkyl, aryl, arakyl, alkylhydroxyaryl or arylhydronyalkyl groups having three to about 20 carbon atoms. The skill in the art will find valuable advice for choosing these components in international patent WO 98/14416.

### Chain Transfer Agents

Chain transfer agents may also be included during the preparation of copolymers of the present invention. The chain transfer reaction in a radical polymerization involves a process in which the polymer radical reacts with another molecule (monomer, polymers, catalyst, solvent, modifier, etc.) forming a dead polymer and a new radical. By using chain transfer agents it is also possible to control the molecular weight of the polymers, copolymers and olgomers. Polymers can be designed with an appropriate molecular weight to provide specific properties that can yield products suitable for a variety of applications. Numerous examples are known in the literature of chain transfer agents that may be useful in the preparation of polymers and copolymers. Examples include but are not limited to acetone, water, oxygen, chloroform, methyl idodite, benzene, halogenated benzenes, alkylated benzenes, toluene, xylene, acetophenone, 2-butanone, methanol, propanol, butyl alcohol, sec-butyl alcohol, ethylhexyl alcohol, butanediol, carbon tetrachloride, carbon tetrabromide, iodoform, chloroform, glycerol, cumene, cyclohexane, crotonaldehyde, aniline, dimethyl aniline, dimethyl toluidine, tripropyl amine, diethyl zinc, anisol, butyl amine, phenols, naphthols, butyraldehyde, isobutyraldehyde, dioxane, dibutyl phosphine, benzyl sulfide, benzyl disulfide, p-anysoyl disulfide, butanethiol, 1-dodecanethiol, mercapto ethanol, sulfinure, dodecyl mercapthane, 1-hexanethiol, lauryl disulfide, mesityl disulfide, 1-nathalene thiol, 1-naphtahloyl disulfide, other thioethers and thioesters. Other chain transfer agents may be included as for example those described in Polymer Handbook, 3^{rd} edition, J. Brandrup and E. H. Immergut, John Wiley & Sons.

### Preparation of Mixtures of Product Q and Other Thermosettable, or Thermoplastic Moieties or Monomers

The copolymers in accordance with the invention can be used individually or as a mixture, where the term mixture is to be understood broadly. It includes both mixtures of different copolymers of this invention as well as mixtures of copolymers that comprise but is not limited to polymerization reactions prepared by condensation, addition polymerization, anionic polymerization, cationic polymerization, metal catalyzed polymerization, ring opening polymerization, thermal polymerization, and radical polymerization, such polymers include: saturated polyester resins (e.g., resins employed in hot melt adhesives, low profile agents and powder coatings), unsaturated polyesters (e.g., resins used in forming molded articles), aliphatic and aromatic polyethers, vinyl ester resins (e.g., resins used in filament winding and open and closed molding), polyurethanes, styrenic resins, acrylic resins, polypropylene, polyethylene, ethylene and propylene oxide polymers and copolymers, butadiene resins, and mixtures of any of the above.

### Thermosettable or Thermoplastic Moieites for the Mixture

1.) Unsaturated Polyesters

For the purpose of the invention, unsaturated polyester resins, saturated polyester resins and vinyl ester resins are preferably employed. An unsaturated polyester resin may be formed from conventional methods. Typically, the resin is formed from the reaction between a polyfunctional organic acid or anhydride and a polyhydric alcohol under conditions known in the art. The polyfunctional organic acid or anhydride which may be employed are any of the numerous and known compounds. Suitable polyfunctional acids or anhydrides thereof include, but are not limited to, maleic acid, fumaric acid, citraconic acid, itaconic acid, glutaconic acid, phthalic acid, isophthalic acid, terephthalic acid, tetrahydrophthalic anhydride, cyclohexane dicarboxylic acid, succinic anhydride, adipic acid, sebacic acid, azelaic acid, malonic acid, alkenyl succinic acids such as n-dodecenyl succinic acid, dodecylsuccinic acid, octadecenyl succinic acid, and anhydrides thereof. Lower alkyl esters of any of the above may also be employed. Mixtures of any of the above are suitable, without limitation intended by this.

Additionally, polybasic acids or anhydrides thereof having not less than three carboxylic acid groups may be employed. Such compounds include 1,2,4-benzenetricarboxylic acid, 1,3,5-benzene tricarboxylic acid, 1,2,4-cyclohexane tricarboxylic acid, 2,5,7-naphthalene tricarboxylic acid, 1,2,4-naphthalene tricarboxylic acid, 1,3,4-butane tricarboxylic acid, 1,2,5-hexane tricarboxylic acid, 1,3-dicarboxyl-2-methyl-2-carboxymethylpropane, tetra(carboxymethyl)methane, 1,2,7,8-octane tetracarboxylic acid, and mixtures thereof.

Suitable polyhydric alcohols which may be used in forming the unsaturated polyester resins include, but are not limited to, ethylene glycol, diethylene glycol, propylene glycol, dipropylene glycol, 1,3-butanediol, 1,4-butanediol, 1,3-hexanediol, neopentyl glycol, 2-methyl-1,3-pentanediol, 1,3-butylene glycol, 1,6-hexanediol, hydrogeneated bisphenol “A”, cyclohexane dimethanol, 1,4-cyclohexanol, ethylene oxide adducts of bisphenols, propylene oxide adducts of bisphenols, sorbitol, 1,2,3,6-hexatetrol, 1,4-sorbitan, pentaerythritol, dipentaerythritol, tripentaerythritol, sucrose, 1,2,4-butanetriol, 1,2,5-pentanetriol, glycerol, 2-methyl-propanetriol, 2-methyl-1,2,4-butanetriol, trimethylol ethane, trimethylol propane, and 1,3,5-trihydroxyethyl benzene. Mixtures of any of the above alcohols may be used.

DCPD resins used in the composition of the invention are known to those skilled in the art. These resins are typically DCPD polyester resins and derivatives, which may be made according to various accepted procedures. As an example, these resins may be made by reacting DCPD, ethylenically unsaturated dicarboxylic acids, and compounds having two groups wherein each contains a reactive hydrogen atom that is reactive with carboxylic acid groups. DCPD resins made from DCPD, maleic anhydride phthalic anhydride, isophthalic acid, terephthalic acid, adipic acid, water, and a glycol such as, but not limited to, ethylene glycol, propylene glycol, diethylene glycol, neopentyl glycol, dipropylene glycol, and poly-tetramethylene glycol, are particularly preferred for the purposes of the invention. The DCPD resin may also include nadic acid ester segments that may be prepared in-situ from the reaction of pentadiene and maleic anhydride or added in its anhydride form during the preparation of the polyester.

The DCPD resin may be used in various amounts in the laminating resin composition of the invention. Preferably, the laminating resin composition comprises from about 10 to about 80 weight percent of DCPD resin, and more preferably from about 20 to about 40 weight percent. Preferably, the DCPD resin has a number average molecular weight ranging from about 450 to about 1500, and more preferably from about 500 to about 1000. Additionally, the DCPD resin preferably has an ethylenically unsaturated monomer content of below 35 percent at an application viscosity of 200 to 800 cps.

2.) Vinyl Esters

The vinyl ester resins employed in the invention include the reaction product of an unsaturated monocarboxylic acid or anhydride with an epoxy resin. Exemplary acids and anhydrides include (meth)acrylic acid or anhydride, α-phenylacrylic acid, α-chloroacrylic acid, crotonic acid, mono-methyl and mono-ethyl esters of maleic acid or fumaric acid, vinyl acetic acid, sorbic acid, cinnamic acid, and the like, along with mixtures thereof. Epoxy resins which may be employed are known and include virtually any reaction product of a polyfunctional halohydrin, such as epichlorohydrin, with a phenol or polyhydric phenol. Suitable phenols or polyhydric phenols include, for example, resorcinol, tetraphenol ethane, and various bisphenols such as Bisphenol “A”, 4,4′-dihydroxydiphenyl sulfone, 4,4′-dihydrohy byphenyl, 4,4′-dihydroxydiphenyl methane, 2,2′-dihydoxydiphenyloxide, and the like. Novolac epoxy resins may also be used. Mixtures of any of the above may be used. Additionally, the vinyl ester resins may have pendant carboxyl groups formed from the reaction of esters and anhydrides and the hydroxyl groups of the vinyl ester backbone.

Other components in the resin may include epoxy acrylate oligomers known to those who are skilled in the art. As an example, the term “epoxy acrylates oligomer” may be defined for the purposes of the invention as a reaction product of acrylic acid and/or methacrylic acid with an epoxy resin. Examples of processes involving the making of epoxy acrylates can be found in U.S. Pat. No. 3,179,623, the disclosure of which is incorporated herein by reference in its entirety. Epoxy resins that may be employed are known and include virtually any reaction product of a polyfunctional halohydrin, such as, but not limited to, epichlorohydrin, with a phenol or polyhydric phenol. Examples of phenols or polyhydric phenols include, but are not limited to, resorcinol, tetraphenol ethane, and various bisphenols such as Bisphenol-A, 4,4′-dihydroxy buiphenyl, 4,4′-dihydroxydiphenylmethane, 2,2′-dihydroxydiphenyloxide, phenol or cresol formaldehyde condensates and the like. Mixtures of any of the above can be used. The preferred epoxy resins employed in forming the epoxy acrylates are those derived from bisphenol A, bisphenol F, especially preferred are their liquid condensates with epichlorohydrin having a molecular weight preferably in the range of from about 300 to about 800. The preferred epoxy acrylates that are employed of the general formula: 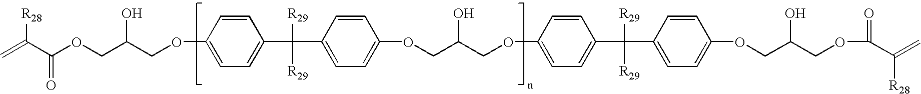
where R₂₈ and R₂₉ is H or CH₃ and n ranges from 0 to 1, more preferably from 0 to 0.3.

Other examples of epoxy acrylate oligomers that may be used include comparatively low viscosity epoxy acrylates. As an example, these materials can be obtained by reaction of epichlorohydrin with the diglycidyl ether of an aliphatic diol or polyol.

3.) Polyurethane Acrylates

Polyacrylates are also useful in the preparation of the molding compositions of the present invention. A urethane poly(acrylate) characterized by the following empirical formula may used as part of the mixtures: 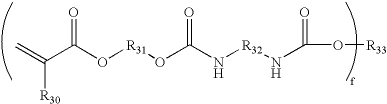
wherein R₃₀ is hydrogen or methyl; R₃₁ is a linear or branched divalent alkylene or oxyalkylene radical having from 2 to 5 carbon atoms; R₃₂ is a divalent radical remaining after reaction of a substituted or unsubstituted diisocyanate; R₃₃ is the hydroxyl free residue of an organic polyhydric alcohol which contained hydroxyl groups bonded to different atoms; and f has an average value of from 2 to 4. The compounds are typically the reaction products of polyols in which the hydroxyl groups are first reacted with a diisocyanate using one equivalent of diisocyanate per hydroxyl group, and the free isocyanate groups are the reacted with a hydroxyalkyl ester of acrylic or methacrylic acid.

The polyhydric alcohol suitable for preparing the urethane poly(acrylate) typically contains at least two carbon atoms ad may contain from 2 to 4, inclusive, hydroxyl groups. Polyols based on the polycaprolactone ester of a polyhydric alcohol such as described in, for example U.S. Pat. No. 3,169,945 are included. Unsaturated polyols may also be used such as those described in U.S. Pat. No. 3,929,929 and U.S. Pat. No. 4,182,830, the disclosures of which are incorporated by reference in their entirety.

Diisocyanates suitable for preparing the urethane poly(acrylate) are well known in the art and include aromatic, aliphatic, and cycloaliphatic diisocyanates. Such isocyanates may be extended with small amounts of glycols to lower their melting point and provide a liquid isocyanate. The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however.

Urethane poly(acrylates) such as the above are described in for example, U.S. Pat. No. 3,700,643; U.S. Pat. No. 4,131,602; U.S. Pat. No. 4,213,837; U.S. Pat. No. 3,772,404 and U.S. Pat. No. 4,777,209, the disclosures of which are incorporated by reference in their entirety.

A urethane poly(acrylate) characterized by the following empirical formula: 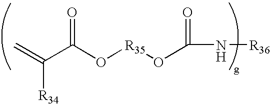
where R₃₄ is hydrogen or methyl; R₃₅ is a linear or branched alkylene or oxyalkylene radical having from 2 to about 6 carbon atoms; R₃₆ is the polyvalent residue remaining after the reaction of a substituted or unsubstituted polyisocyanate; and g has an average value of from about 2 to 4. These compounds are typically the reaction products of a polyisocyanate with a hydroxyalkyl ester per isocyanate group.

Polyisocyanates suitable for preparing the urethane poly(acrylates) are well known in the art and include aromatic, aliphatic and cycloaliphatic polyisocyanates. Some diisocyanates may be extended with small amounts of glycol to lower their melting point and provide a liquid isocynate.

Urethanes poly(acrylates) such as the above are described in, for example U.S. Pat. No. 3,297,745 and British Patent No. 1,159,552, the disclosures of which are incorporated by reference in their entirety.

A half-ester or half-amide characterized by the following formula: 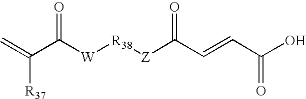
wherein R₃₇ is hydrogen or methyl. R₃₈ is an aliphatic or aromatic radical containing from 2 to about 20 carbon atoms, optionally containing —O— or 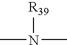
W and Z are independently —O— or 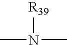
And R₃₉ is hydrogen or low alkyl. Such compounds are typically the half-ester or half-amide product formed by the reaction of a hydroxyl, amino, or alkylamino containing ester or amide derivatives of acrylic or methacrylic acid with maleic anhydride, maleic acid, or fumaric acid. These are described in, for example, U.S. Pat. No. 3,150,118 and U.S. Pat. No. 3,367,992, the disclosures of which are incorporated by reference in their entirety.
4.) Isocyanurate Acrylates

An unsaturated isocyanurate characterized by the following empirical formula: 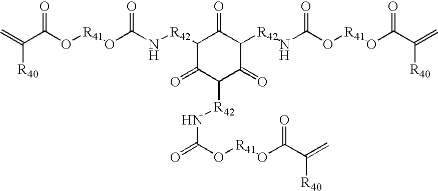
wherein R₄₀ is a hydrogen or methyl, R₄₁ is a linear or branched alkylene or oxyalkylene radical having from 2 to 6 carbon atoms, and R₄₂ is a divalent radical remaining after reaction of a substituted or unsubstituted diisocyanate. Such products are typically produced by the reaction of a diisocyanate reacted with one equivalent of a hydroxyalkyl ester of acrylic or methacrylic acid followed by the trimerization reaction of the remaining free isocyanate.

It is understood that during the formation of the isocyanurate, a diisocyanate may participate in the formation of two isocyanurate rings thereby forming crosslinked structures in which the isocyanurate rings may be linked by the diisocyanate used. Polyiisocyanates might also be used to increase this type of crosslink formation.

Diisocyanates suitable for preparing the urethane poly(acrylate) are well known in the art and include aromatic, aliphatic, and cycloaliphatic diisocyanates. Such isocyanates may be extended with small amounts of glycols to lower their melting point and provide a liquid isocyanate.

The hydroxyalkyl esters suitable for final reaction with the polyisocyanate formed from the polyol and diisocyanate are exemplified by hydroxylacrylate, hydroxypropyl acrylate, hydroxyethyl methacrylate, and hydroxypropyl methacrylate. Any acrylate or methacrylate ester or amide containing an isocyanate reactive group may be used herein, however. Other alcohols containing one hydroxyl group may also be used. The monoalcohols may be monomeric or polymeric.

Such unsaturated isocyanurates are described in, for example, U.S. Pat. No. 4,195,146.

5.) Polyamide Ester Acrylates

Poly(amide-esters) as characterized by the following empirical formula: 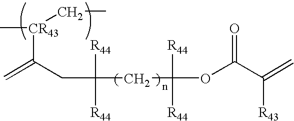
wherein R₄₃ is independently hydrogen or methyl, R₄₄ is independently hydrogen or lower alkyl, and h is 0 or 1. These compounds are typically the reaction product of a vinyl addition prepolymer having a plurality of pendant oxazoline or 5,6-dihydro-4H-1,3-oxazine groups with acrylic or methacrylic acid. Such poly(amide-esters) are described in, for example, British Pat. No. 1,490,308.

A poly(acrylamide) or poly(acrylate-acrylamide) characterized by the following empirical fomula: 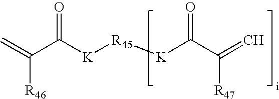
wherein R₄₅ is the polyvalent residue of an organic polyhydric amine or polyhydric aminoalcohol which contained primary or secondary amino groups bonded to different carbon atoms or, in the case of an aminoalcohol, amine and alcohol groups bonded to different carbon atoms; R₄₆ and R₄₇ are independently hydrogen or methyl; K is independently —O— or 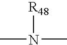
R₄₈ is hydrogen or lower alkyl; and i is 1 to 3.

The polyhydric amines suitable for preparing the poly(acrylamide) contains at least two carbon atoms and may contain 2 to 4, inclusive, amine or alcohol groups, with the proviso that at least one group is a primary or a secondary amine. These include alkane aminoalcohols and aromatic containing aminoalcohols. Also included are polyhydric aminoalcohols containing ether, amino, amide, and ester groups in the organic residue.

Examples of the above compounds are described, in for example, Japanese publications Nos. JP80030502, JP80030503, and JP800330504 and U.S. Pat. No. 3,470,079 and British Patent No. 905,186.

It is understood by those skilled in the art that the thermosetable organic materials described, supra, are only representative of those which may be used in the practice of this invention.

6.) Saturated Polyesters and Urethanes

Saturated polyester and polyurethanes include, for example, those described in U.S. Pat. No. 4,871,811, U.S. Pat. No. 3,427,346 and U.S. Pat. No. 4,760,111, the disclosures of which are incorporated herein by reference in their entirety. The saturated polyester resins and polyurethanes are particularly useful in hand lay-up, spray up, sheet molding compounding, hot melt adhesives and pressure sensitive adhesives applications. Appropriate saturated polyester resins include, but are not limited to, crystalline and amorphous resins. The resins may be formed by any suitable technique. For example, the saturated polyester resin may be formed by the polycondensation of an aromatic or aliphatic di- or polycarboxylic acid and an aliphatic or alicylcic di- or polyol or its prepolymer. Optionally, either the polyols may be added in an excess to obtain hydroxyl end groups or the dicarboxylic monomers may be added in an excess to obtain carboxylic end groups. Suitable polyurethane resins may be formed by the reaction of diols or polyols as those described in U.S. Pat. No. 4,760,111 and diisocyantes. The diols are added in an excess to obtain hydroxyl terminal groups at the chain ends of the polyurethane. The saturated polyesters and polyurethanes may also contain other various components such as, for example, an ethylene-vinyl acetate copolymer, an ethylene-ethyl acrylate copolymer, and the like.

7.) Thermoplastic Polymers—Low Profile Agents

Thermoplastic polymeric materials which reduce shrinkage during molding can also be included in the composition of the invention. These thermoplastic materials can be used to produce molded articles having surfaces of improve smoothness. The thermoplastic resin is added into the unsaturated polyester composition according to the invention in order to suppress shrinkage at the time of curing. The thermoplastic resin is provided in a liquid form and is prepared in such a manner that 30 to 45 percent by weight of the thermoplastic resin is dissolved in 55 to 70 percent by weight of polymerizable monomer having some polymerizable double bond in one molecule. Examples of the thermoplastic resin may include styrene-base polymers, polyethylene, polyvinyl acetate base polymer, polyvinyl chloride polymers, polyethyl methacrylate, polymethyl methacrylate or copolymers, ABS copolymers, hydrogenated ABS, polycaprolactone, polyurethanes, butadiene styrene copolymer, and saturated polyester resins. Additional examples of thermoplastics are copolymers of: vinyl chloride and vinyl acetate; vinyl acetate and acrylic acid or methacrylic acid; styrene and acrylonitrile; styrene acrylic acid and allyl acrylates or methacylates; methyl methacrylate and alkyl ester of acrylic acid; methyl methacrylate and styrene; methyl methacrylate and acrylamide. In the resin composition according to the invention, 5 to 50 percent by weight of the liquid thermoplastic resin is mixed, preferably 10 to 30 percent by weight of the liquid thermoplastic resin is mixed.

Low profile agents (LPA) are composed primarily of thermoplastic polymeric materials. These thermoplastic intermediates present some problems remaining compatible with almost all types of thermosetting resin systems. The incompatibility between the polymeric materials introduces processing difficulties due to the poor homogeneity between the resins. Problems encountered due to phase separation in the resin mixture include, scumming, poor color uniformity, low surface smoothness and low gloss. It is therefore important to incorporate components that the will help on stabilizing the resin mixture to obtain homogeneous systems that will not separate after their preparation. For this purpose, a variety of stabilizers can be used in the present invention which includes block copolymers from polystyrene-polyethylene oxide as those described in U.S. Pat. No. 3,836,600 and U.S. Pat. No. 3,947,422, the disclosures of which are incorporated by reference in their entirety. Block copolymer stabilizers made from styrene and a half ester of maleic anhydride containing polyethylene oxide as described in U.S. Pat. No. 3,947,422. Also useful stabilizers are saturated polyesters prepared from hexanediol, adipic acid and polyethylene oxide available from BYK Chemie under code number W-972. Other type of stabilizers may also include addition type polymers prepared from vinyl acetate block copolymer and a saturated polyester as described in Japanese Unexamined Patent application No. Hei 3-174424.

8.) Fatty Acid Intermediates

Fatty acids may be used in the preparation of polyesters without restriction. Although prepolymerized fatty acids or their fatty acid esters prepared according to known processes are usually used. A polybasic polymerized fatty acid prepared by polymerizing a higher fatty acid or higher fatty acid ester is preferable because can provide better adhesiveness, flexibility, water resistant and heat resistance, providing a well balance mixture with improved properties. The fatty acid may be any of saturated and unsaturated fatty acids, and the number of carbons may be from 8 to 30, preferably 12 to 24, and further preferably 16 to 20. As the fatty ester, alkyl esters, such as methyl, ethyl, propyl, butyl, amyl and cyclohexyl esters and the like may be used.

Preferable polymerized fatty acids include polymerized products of unsaturated higher fatty acids such as oleic acid, linoleic acid, resinoleic acid, eleacostearic acid and the like. Polymerized products of tall oil fatty acid, beef tallow fatty acid and the like, etc., can be also used. Hydrogenated polymerized fatty esters or oils can also be used. Portions of the dibasic carboxylic acid (herein after referred to as “dimer acid”) and three or higher basic carboxylic acid in the polymerized fatty acid is not particularly limited, but the proportions may be selected appropriately according to the ultimate properties expected. Trimer acids or higher carboxylic acids may also be used.

The polymerization of the fatty acid esters is not particularly limited, alkyl esters of the above mentioned polymerized fatty acids are usually used as the polymerized fatty acid esters. As said alkyl esters such as methyl ester, ethyl ester, propyl ester, isopropyl ester, butyl ester, amyl ester, hexyl ester and the like and higher alkyl esters such as octyl ester, decyl ester, dodecyl ester, pentadecyl ester, octadecyl ester and the like can be used, among which preferable are lower alkyl esters and more preferable are methyl ester, ethyl ester and butyl ester.

These polymerized fatty acids and polymerized fatty acid esters can be used either alone or in combination of two or more. Although proportion of the sum of the polymerized fatty acids and the polymerized fatty acid esters in the total polybasic carboxylic acid is not particularly limited and may be used in different rations ranging from 3 to 40 percent by weight of the resin composition.

9.) Epoxy Intermediates

Also compounds that may be included in this invention are epoxy compounds which include a wide variety of epoxy compounds. Typically, the epoxy compounds are epoxy resins which are also referred as polyepoxides. Polyepoxides useful herein can be monomeric (i.e. the diglycidyl ether of bisphenol A), advanced higher molecular weight resins, or polymerized unsaturated monoepoxides (i.e., glycidyl acrylates, glycidyl methacrylates, allyl glycidyl ether, etc.) to homopolymers or copolymers. Most desirable, epoxy compounds contain, on the average, at least one pendant or terminal 1,2-epoxy group (i.e., vicinal epoxy group per molecule).

Examples of the useful polyepoxides include the polyglicidyl ethers of both polyhydric alcohols and polyhydric phenols; polyglycidyl amines, polyglycidyl amides, polyglycidyl imides, polyglycidyl hydantoins, polyglycidyl thioethers, polyglycidyl fatty acids, or drying oils, epoxidized polyolefins, epoxidized diunsaturated acid esters, epoxidized unsaturated polyesters, and mixtures thereof. Numerous epoxides prepared from polyhydric phenols include those which are disclosed, for example, in U.S. Pat. No. 4,431,782. Polyepoxides can be prepared from mono-, di- and trihydric phenols, and can include the novolac resins. The polyepoxides can include the epoxidized cycloolefins; as well as the polymeric polyepoxides which are polymers and copolymers of glycidyl acrylates, glycidyl methacrylate and allylglycidyl ether. Suitable polyepoxides are disclosed in U.S. Pat. No. 3,804,735; U.S. Pat. No. 3,893,829; U.S. Pat. Nos. 3,948,698; 4,014,771 and U.S. Pat. No. 4,119,609; and Lee and Naville, Handbook of Epoxy Resins, Chapter 2, McGraw Hill, New York (1967).

While the invention is applicable to a variety of polyepoxides, generally preferred polyspoxides are glycidyl polyethers of polyhydric alcohols or polyhydric phenols having weights per epoxide of 150 to 2,000. These polysepoxides are usually made by reacting at least about two moles of an epihalohydrin or glycerol dihalohydrin with one mole of the polyhydric alcohol or polyhydric phenol, and sufficient amount of a caustic alkali to combine with the halogen of the halohydrin. The products are characterized by the presence of more than one epoxide group, i.e., a 1,2-epoxy equivalency greater than one.

The compositions may also include a monoepoxide, such as butyl glycidyl ether, phenyl glycidyl ether, or cresyl glycidyl ether, as a reactive diluent. Such reactive diluents are commonly added to polyepoxide formulations to reduce the working viscosity thereof, and to give better wetting to the formulation.

Other monomers that may be included in the compositions of the present invention are acetyl acetonates that can be monofunctional or polyfunctional. Examples include but are not limited to methyl acetoacetate, ethyl acetoacetate, t-butyl acetoacetate, 2thylhexyl acetoacetate, lauryl acetoacetate, acetoacetanilide, butanediol diacetoacetate, 1,6-hexanediol diacetoacetate, neopentyl glycol diacetoacetate, cyclohexane dimethanol diacetoacetate, ethoxylated bisphenol A diacetoacetate, trimethylolpropane triacetoacetate, glycerin triacetoacetate, polycaprolantone triacetoacetate, pentaerythritol tetraacetoacetate.

10.) Inhibitors Additives in the Mixture of Product Q and Epoxy Moieties

Additives may also include inhibitors added to the resin mix to stop or delay any crosslinking chain reaction that might be started by the possible formation of free radicals. Because free radicals can be formed at the carbon-carbon double bonds through several different mechanisms, such as interactions between molecules with heat and light, the possibility of the formation of free radicals is quite high. Should this occur there is a good possibility that the resin could crosslink during storage. Therefore, the right amount of inhibitor in the system is necessary to minimize stability problems. Suitable inhibitor may include but are not limited to, hydroquinone (HQ), tolu-hydroquinone (THQ), bisphenol “A” (BPA), naphthoquinone (NQ), p-benzoquinone (p-BQ), butylated hydroxy toluene (BHT), hydroquinone monomethyl ether (HQMME), monotertiary butyl hydroquinone (MTBHQ), ditertiary butyl hydroquinone (DTBHQ), tertiary butyl catechol (TBC), and other substituted and unsubstituted phenols and mixtures of the above.

11.) Antioxidants

Additional additives include phenolic type antioxidants as those described in pages 1 to 104 in “Plastic additives”, by R. Gächter and Müller, Hanser Publishers, 1990. Include also are Mannich type antioxidants, specially phenols and naphthols, suitable for the purpose herein include hindered aromatic alcohols, such as hindered phenols and naphthols, for example, those described in U.S. Pat. No. 4,324,717, the disclosure of which is incorporated herein by reference in its entirety.

12.) Fiber Reinforcement

The addition of fiber(s) provide a means for strengthening or stiffening the polymerized cured composition. The types often used are:

Inorganic crystals or polymers, e.g., fibrous glass, quartz fibers, silica fibers, fibrous ceramics, e.g., alumina-silica (refractory ceramic fibers); boron fibers, silicon carbide, silicon carbide whiskers or monofilament, metal oxide fibers, including alumina-boria-silica, alumina-chromia-silica, zirconia-silica, and others;

Organic polymer fibers, e.g., fibrous carbon, fibrous graphite, acetates, acrylics (including acrylonitrile), aliphatic polyamides (e.g. nylon), aromatic polyamides, olefins (e.g., polypropylenes, polyesters, ultrahigh molecular weight polyethylenes), polyurethanes (e.g., Spandex), alpha-cellulose, cellulose, regenerated cellulose (e.g., rayon), jutes, sisal, vinyl chlorides, vinylidenes, flax, and thermoplastic fibers;

Metal fibers, e.g., aluminum, boron, bronze, chromium, nickel, stainless steel, titanium or their alloys; and “whiskers”, single, inorganic crystals.

13.) Fillers

Suitable filler(s) non-fibrous are inert, particulate additives being essentially a means of reducing the cost of the final product while often reducing some of the physical properties of the polymerized cured compound. Fillers used in the invention include calcium carbonate of various form and origins, silica of various forms and origins, silicates, silicon dioxides of various forms and origins, clays of various forms and origins, feldspar, kaolin, flax, zirconia, calcium sulfates, micas, talcs, wood in various forms, glass(milled, platelets, spheres, micro-balloons), plastics (milled, platelets, spheres, micro-balloons), recycled polymer composite particles, metals in various forms, metallic oxides or hydroxides (except those that alter shelf life or viscosity), metal hydrides or metal hydrates, carbon particles or granules, alumina, alumina powder, aramid, bronze, carbon black, carbon fiber, cellulose, alpha cellulose, coal (powder), cotton, fibrous glass, graphite, jute, molybdenum, nylon, orlon, rayon, silica amorphous, sisal fibers, fluorocarbons and wood flour.

The fibrous materials may be incorporated into the resin in accordance with techniques which are known in the art. Fillers may include but are not limited to calcium carbonate, calcium sulfate, talc, aluminum oxide, aluminum hydroxide, silica gel, barite, carbon powder, etc. Preferably, the filler is added in amount between 0 to 80 percent by weight and more preferably in an amount of 20 to 60 percent by weight based on the resin composition.

14.) Thickening Agents

Optionally a thickening agent is added if compositions are used for BMC or SMC compounding, in the range of 0.05 to 10 percent, preferably in the range of 0.2 to 5 percent by weight of the chemical thickener, based on the weight of the molding compound. The thickening agent is added to facilitate increasing the viscosity of the compounding mixture. Examples include CaO, Ca(OH)₂, MgO or Mg(OH)₂. Any suitable chemical thickener contemplated by one skill in the molding compound art may be used. The thickening agent(s) coordinate with carboxyl groups present in the polymer of the present invention or to any other polymer added therewith from those described above.

Other thickening agents that may also be included are isocyanates. These materials react with hydroxyl groups that may be present in the polymers of this invention or in other polymer added therewith from those described above. Polyisocyanates employed in the present invention are aromatic, aliphatic and cycloaliphatic polyisocyanates having 2 or more isocyanate groups per molecule and having an isocyanate equivalent weight of less than 300. Preferably the isocyanates are essentially free from ethylenic unsaturation and have no other substituents capable of reacting with the unsaturated polyester. Polyfunctional isocyanates which are used in the above reactions are well known to the skilled artisan. For the purposes of the invention, diisocyantes include aliphatic, cycloaliphatic, araliphatic, aromatic and heterocyclic diisocyantes of the type described, for example, by W. Siefken in Justus Liebigs Annalen der Chemie, 562, pages 75 to 136, (1949) for example, those corresponding to the following formula:
OCN—R₄₉—(NCO)ₙ
wherein n is equal to 1 to 3 and R₄₉ represents a difunctional aliphatic, cycloaliphatic, aromatic, or araliphatic radical having from about 4 to 25 carbon atoms, preferably 4 to 15 carbon atoms, and free of any group which can react with isocyanate groups. Exemplary diisocyantes include, but are not limited to, toluene diisocyanate; 1,4-tetramethylene diisocyanate; 1,4-hexamethylene diisocyanate; 1,6-hexamethylene diisocyanate; 1,12-dodecane diisocyante; cyclobutane-1,3-diisocyanate; cyclohexane-1,3-diisocyanate; cyclohexane-1,4-diisocyanate; 1-isocyanato-3,3,5-trimethyl-5-isocyanatomethyl cyclohexane; 2,4-hexahydrotolylene diisocyanate; 2,6-hexahydrotolylene diisocyanate; 2,6-hexahydro-1,3-phenylene diisocyanate; 2,6-hexahydro-1,4-phenylene diisocyanate; per-hydro-2,4′-diphenyl methane diisocyanate; per-hydro-4,4′-diphenyl methane diisocyanate; 1,3-phenylene diisocyanate; 1,4-phenylene diisocyanate; 2,4-tolylene diisocyanate, 2,6-toluene diisocyanates; diphenyl methane-2,4′-diisocyanate; diphenyl methane-4,4′-diisocyanate; naphthalene-1,5-diisocyanate; 1,3-xylylene diisocyanate; 1,4-xylylene diisocyanate; 4,4′-methylene-bis(cyclohexyl isocyanate); 4,4′-isopropyl-bis-(cyclohexyl isocyanate); 1,4-cyclohexyl diisocyanate; 3-isocyanatomethyl-3,5,5-trimethylcyclohexyl isocyanate (IPDI); 1-methyoxy-2,4-phenylene diisocyanate; 1-chloropyhenyl-2,4-diisocyante; p-(1-isocyanatoethyl)-phenyl isocyanate; m-(3-isocyanatobutyl)-phenyl isocyanate; and 4-(2-isocyanate-cyclohexyl-methyl)-phenyl isocyanate. Mixtures of any of the above may be employed. When deemed appropriate, a diisocyante may be employed which contains other functional groups such as amino functionality.

The preferred polyfunctional isocyanate additive of the molding compositions of this invention consists of a dual-functional additive prepared by the one step-addition reaction between one equivalent weight of a diol or triol of molecular weight from 60 to 3000 and an excess of the polyfunctional isocyanate. The polyfunctional isocyanate excess is added in a quantity sufficient to allow unreacted polyfunctional isocyanate remain free in the mixture after the reaction with the diol or triol in an amount of 0.01 to 50% by weight of the total mixture and most preferable in an amount of 1 to 30% by weight of the mixture. In the reaction involving the diol or triol with the polyfunctional isocyanate, it is preferred to employ a catalyst. A number of catalysts know to the skill artisan may be used for this purpose. Suitable catalysts are described in U.S. Pat. Nos. 5,925,409 and 4,857,579, the disclosures of which are hereby incorporated by reference. Examples of the polyhydric alcohol having at least 2 hydroxyl groups in the molecule and a hydroxyl value of 35 to 1,100 mg KOH/g include ethylene glycol, propylene glycol, diethylene glycol, triethylene glycol, 1,5-pentane diol, 1,6-hexane diol, polyethylene glycol and polypropylene having a molecular weight of 200 to 3000, polytetramethylene glycol having a molecular weight of 200 to 3000, etc.

The process of the invention may employ a carbodiimide, preferably a carbodiimide intermediate containing from about 1 to about 1000 repeating units. Polycarbodiimides are preferably utilized. The carbodiimides depending on the amount added are used to react with the resin or components having active hydrogens, e.g., to lower the acid number of the unsaturated polyester resin or to increase the viscosity of the resins to form a gel like material. Exemplary carbodiimides are described in U.S. Pat. No. 5,115,072 to Nava et al., the disclosure of which is incorporated herein by reference in its entirety.

In general, the carbodiimides preferably are polycarbodiimides that include aliphatic, cycloaliphatic, or aromatic polycarbodiimides. The polycarbodiimides can be prepared by a number of reaction schemes known to those skilled in the art. For example, the polycarbodiimides may be synthesized by reacting an isocyanate-containing intermediate and a diisocyante under suitable reaction conditions. The isocyanate containing intermediate may be formed by the reaction between a component, typically a monomer containing active hydrogens, and a diisocyanate. Included are also polycarbodiimides prepared by the polymerization of isocyanates to form a polycarbodiimide, which subsequently react with a component containing active hydrogens.

Preferably, the carbodiimide intermediate is represented by the formula selected from the group consisting of: 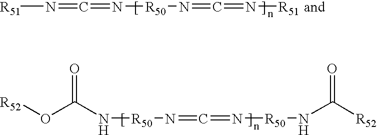
wherein:

R₅₀ and R₅₁ are independently selected from the group consisting of alky, aryl, and a compound containing at least one radical;

R₅₂ may be a monomeric unit or a polymeric unit having from 1 to 1000 repeating units; and

n ranges from 0 to 100;

The carbodiimide is preferably used in a percentage ranging from about 0.10 to about 50 based on the weight of reactants, and more preferably from about 1 to about 20 percent.

15.) Other Additives

Additional additives known by the skilled artisan may be employed in the resin composition of the present invention including, for example, paraffins, lubricants, flow agents, air release agents, flow agents, wetting agents, UV stabilizers, radiation curing initiators (i.e., UV curing initiators) and shrink-reducing additives. Various percentages of these additives can be used in the resin compositions. Internal release agents are preferably added to the molding composition according to the invention. Aliphatic metal slats such as zinc stearate, magnesium stearate, calcium stearate or aluminum stearate can be used as the internal release agent. The amount of internal release agent added is in the range of 0.5 to 5.0 percent by weight, more preferably in the range of from 0.4 to 4.0 percent by weight. Hence, stable release can be made at the time of demolding without occurrence of any crack on the molded product.

Acrylic resins prepared by radical polymerization may be used in the mixtures. The acrylic resin preferably has an acid number ranging from about 1 to 100 mg of KOH/g, more preferably from about 5 to 50 mg of KOH/g, and most preferably from about 10 to 30 mg of KOH/g. The acrylic resin preferably has a hydroxyl number ranging from 5 to 300, more preferably from about 25 to 200, and most preferably from 50 to 150. The acrylic resin has a preferred number average molecular weight, determined by GPC versus polystyrene standards, from about 1000 to about 100,000, and more preferably from about 2000 to about 50,000. The acrylic resin has a polydispersity preferably from about 1.5 to about 30, more preferably from about 2 to 15. The Tg of the acrylic resin, measured by Differential Scanning Calorimetry, is preferably from about −30° C. to about 150° C., and more preferably from about −10° C. to about 80° C.

The styrene acrylic resins which are used are preferably formed from about 0.5 to 30 percent by weight of a functional mercaptam which contains carboxyl, hydroxyl, siloxy, or sulfonic acid groups (most preferably from about 1 to 15 percent by weight), and from about 70 to about 99.5 percent by weight of an ethylenically unsaturated monomer (most preferably 85 to 99 percent by weight). Exemplary styrene/acrylic resins are described in Boutevin et al., Eur. Polym. J., 30; No. 5, pp. 615-619, and Rimmer et al, in Polymer, 37; No. 18, pp. 4135-4139. Also included are block copolymers of alkenyl aromatic hydrocarbons and alkylene oxides described in U.S. Pat. Nos. 3,050,511 and 3,836,600.

Various hydroxyl and carboxyl terminated rubbers may be also used as toughening agents. Examples of such materials are presented in U.S. Pat. No. 4,100,229, the disclosure of which is incorporated by reference herein in its entirety; and in J. P. Kennedy, in J. Macromol. Sci. Chem. A21, pp. 929 (1984). Such rubbers include, for example, carbonyl-terminated and hydroxyl polydienes. Exemplary carbonyl-terminated polydienes are commercially available from BF Goodrich of Cleveland, Ohio, under the trade name of Hycar™. Exemplary hydroxyl-terminated Polydienes are commercially available from Atochem, Inc., of Malvern, Pa., and Shell Chemical of Houston, Tex.

A number of polysiloxanes may be used as toughening agents. Examples of suitable polysiloxanes include poly(alkylsiloxanes), (e.g., poly(dimethyl siloxane)), which includes compounds which contain silanol, carboxyl, and hydroxyl groups. Examples of polysiloxanes are described in Chinag and Shu, J. Appl. Pol. Sci. 361, pp. 889-1907, (1988).

Various hydroxyl and carboxyl terminated polyesters prepared from lactones (e.g., gamma-butyrolactone, etha-caprolactone), as described in Zhang and Wang, Macromol. Chem. Phys. 195, 2401-2407 (1994); In't Velt et al., J. Polym. Sci. Part A, 35, 219-216 (1997); Youqing et al., Polym. Bull. 37, 21-28 (1996).

Various Telechelic Polymers as those described in “Telechelic Polymers. Synthesis and Applications”, Editor: Eric J. Goethals, CRC Press, Inc. 1989., are also included in this invention.

Various polyethoxylated and polypropoxylated hydroxyl terminated polyethers derived from alcohols, phenols (including alkyl phenols), and carboxylic acids can be used as toughening agents. Alcohols which may be used in forming these materials include, but are not limited to, tridecyl alcohol, lauryl alcohol, oleyl alcohol, and mixtures thereof. Commercially suitable polyethoxylated and polypropoxylated oleyl alcohol are sold under the trade name of Rhodasurf™ by Rhone-Poulenc of Cranbury, N.J., along with Trycol™ by Emery Industries of Cincinnati, Ohio. Examples of phenols and alkyl phenols which may be used include, but are not limited to, octyl phenol, nonyl phenol, tristyrylphenol, and mixtures thereof. Commercially suitable tristyrylphenols include, but are not limited to, Igepal™ by Rhone-Poulenc, along with Triton™ by Rohm and Haas of Philadelphia, Pa.

16.) Organic Peroxide

The thermosetting resins also include an agent such as an organic peroxide compound to facilitate curing of the composition. Addition of the peroxide is added to the resin mixtures and further reacted at room temperature, via radiation or thermal polymerization. The resulting product is a crosslinked network with a variable degree of crosslinking that depends on the amount of reactive groups within the resin components. Exemplary organic peroxides that are selected from a list that includes, but is not limited to, the following: Diacyl peroxides such as benzoyl peroxides, t-butyl peroxybenzoate; t-amyl peroxybenzoate; ketone peroxides such as mixtures of peroxides and hydroperoxides; methyl isobutyl ketone; 2,4-pentanedione peroxide; methyl ethyl ketone peroxide/perester blend; peroxydocarbonates such as di(n-propyl)peroxydicarbonate, di(sec-butyl)peroxydicarbonate; di(2-ethylhexyl) peroxydicarbonate; bis(4-t-butyl-cyclohexyl) peroxydicarbonate; disopropyl peroxydicarbonate; dicetyl peroxydicarbonate; peroxyesters such as alpha-cumyl peroxydecanoate; alpha-cumyl peroxyneoheptanoate; t-butylperoxyneodecanoate; t-butylperoxypivalate; 1,5-dimethyl 2,5-di(2-ethylhexanoyl peroxy)hexane; t-butylperoxy-2-ethylhexanoate; t-butylperoxy isobutyrate; t-butylperoxymaeic acid; t-butyl-isopropyl carbonate2,5-dimethyl-2,5-di(benzoylperoxy)hexane; t-butylperoxy-aceta; t-butylperoxybenzoate; di-t-butylperoxy acetate; t-butyl peroxybenzoate; di-t-butyl diperoxyphthalate; mixtures of the peroxy esters and peroxyketal; t-amylperoxyneodecanoate; t-amylperoxypivalate; tamylperoxy(2-ethylhexanoate); t-amylperoxyacetate; t-amylperoxy(2-ethylhexanoate); t-amylperoxyacetate; t-amylperoxybenzoate; t-butylperoxy-2-methyl benzoate; dialkylperoxides such as dicumyl peroxide; 2,5-dimethyl-2,5-di(t-butylperoxy)hexane; 2,5-dimethyl-2,5-di(t-butylperoxy)dexyne-3; t-butyl cumyl peroxide; a,a-bis(t-butylperoxy)diisoprylbenzene; di-t-butyl peroxide; hydroperoxides such as 2,5-dihydro-peroxy-2,5-dimethylhexane; cumene hydroperoxide; t-butylhydroperoxide; peroxyketals such as 1,1-di(t-butylperoxy) 3,3,5-trimethylcyclohexane; 1,1-di(t-butylperoxy)cyclohexane; ethyl-3,3-di(t-butylperoxy) butyrate; n-butyl 4,4-bis(t-butylperoxy)pivalate; cyclic peroxyketal; 1,1-di(t-amylperoxy)cyclohexane; 2,2-di-t-amylperoxy propane; azo type initiators such as 2,2′-azobis(2,4-dimethylvaleronitrile); 2,2′azobis(isobutyronitrile); 2,2′azobis(methylbutyronitrile); and 1,1′-azobis(cyanocyclohexane).

The preferred curing catalysts are: diacyl peroxides such as benzoyl peroxides, t-butyl peroxybenzoate; t-amyl peroxybenzoate; ketone peroxides such as mixtures of peroxides and hydroperoxides; methyl isobutyl ketone; 2,4-pentanedione peroxide; and methyl ethyl ketone peroxide/perester blend.

Mixtures of any of the above may be used. The agent is preferably employed in an amount from about 0.3 to 5.0 percent based on the weight of the resin, more preferably from about 1.5 to 2.5 percent by weight, and most preferably from about 1 to 1.25 percent by weight.

17.) Curing Accelerators/Promoters

Suitable curing accelerators or promoters may also be used and include, for example, cobalt naphthanate, cobalt octoate, N,N-diethyl aniline, N,N-dimethyl aniline, N,N-dimethyl acetamide, and N,N-dimethyl p-toluidine. Other salts of lithium, potassium, zirconium, calcium and copper. Mixtures of the above may be used. The curing accelerators or promoters are preferably employed in amounts from about 0.005 to about 1.0 percent by weight, more preferably from about 0.1 to 0.5 percent by weight, and most preferably from about 0.1 to 0.3 percent by weight of the resin.

The unsaturated resins are particularly well suited for forming molded articles, including those used in storage tanks, automobile body panels, boat building, tub showers, culture marble, solid surface, polymer concrete, pipes and inner liners for pipeline reconstruction. The unsaturated resins may be used alone or in conjunction with other appropriate materials. When the resins are used with other materials (e.g., fibrous reinforcements and fillers), they are typically used to form reinforced products such as storage tanks, automobile body panels, boat building, tub showers by any known process such as, for example pultrusion, sheet molding compounding (SMC), spray up, hand lay-up, resin transfer molding, vacuum injection molding, resin transfer molding and vacuum assisted resin transfer molding.

Several advantages are found on the resins from this invention. Since the products have a higher amount of carbon-carbon linkages than any typical thermoset resins containing ester or urethane linkages they are less sensitive to thermal and hydrolytic stability. Replacement of these ester linkages by simple but most stable carbon-carbon sigma bond leads to a more stable unsaturated thermoset resins to both hydrolytically, thermal and as well as chemically resistant. A critical problem with thermosetting resins is that their linear shrinkage can be as high as five percent for most common resins. In addition, the resins of this invention have hydroxyl groups that may be reacted with isocyanates or anhydrides and acid groups that may be reacted with other epoxy containing materials. The acid groups may also be use to coordinate with metal salts such magnesium, zinc or calcium oxide. These reactions are important in the preparation of products for SMC applications, pultrusion, adhesives, and open mold among others. The resins of this invention have low shrink properties alone or in combination with other thermoset or thermoplastic resins. Examples to illustrate these advantages are presented below.

### EXAMPLES

Described below are resins which have been coreacted using the unsaturated polystyrene thermosetting resin. All resins are available from Reichhold, Inc., Durham, N.C. Polylite® 31051-00 is a DCPD/maleic anhydride/diethylene glycol resin use for open mold applications such as spray up and hand lay-up; Polylite® 31453-00 is a DCPD/maleic anhydride/diethylene glycol/ethylene glycol resin use for closed mold applications; Polylite® 33000-00 is a PG/PET/Maleic anhydride resin used in open mold applications; Polylite® 33420-00 is an isophthalic/Maleic anhydride/propylene glycol resin used in close molding applications and cured in placed pipe; Hydrex® 100 HF (33375-00) is a vinyl ester resin used in marine applications, open mold and infusion.

The following examples are provided to illustrate the present invention, and should not be construed as limited thereof. In the examples, resin tensile strength was measured in accordance with ASTM Standard D-638; flexural strength was measured in accordance with ASTM Standard D-79; barcol hardness was determined in accordance with ASTM Standard D-2583; elongation was measured in accordance with ASTM Standard D-638; heat distortion (HDT) was measured in accordance with ASTM Standard D-648, Viscosities were measured with a Brookfield Viscometer with a spindle #4 at 20 rpm and at 25° C.

The following characteristics are used in the examples:

The NV percent is the weight percent of monomer converted to polymer. It was determined gravimetrically. Number-average molecular weight (hereafter “Mn”) and weight-average molecular weight (hereafter “Mw”) are determined by gel permeation chromatography (GPC) in tetrahydrofuran at 25° C., after calibration with standard polystyrene samples of known number-average molecular weight.
The polydispersity index (hereafter “PDI”) is the ratio of the weight-average molecular weight to the number-average molecular weight, both measured by GPC.
All the raw materials used in the examples were commercially available products.
A 5 L five-necked reactor equipped with a mechanical agitator, a condenser, a N₂ inlet and with a temperature controlling mechanism was purged thoroughly with N₂ for a period of 5-10 min. Styrene, glycidyl methacrylate (GMA), ethyl 2-chloropropionate (EtCl), CuCl, Polycat (Pentamethyldiethylenetriamine) were introduced in the reactor in a weight ratio as shown in Table 1.

Reaction mixture was purged with N₂ for 20 min while heating was initiated. When the temperature was reached at 70° C., N₂ purging was stopped and a N₂ blanket was maintained thereafter during the entire reaction. The reactor was then brought to 107° C. with constant agitation. Samples were withdrawn under N₂ at the top heat and every hour thereafter and NV % was determined gravimetrically. When the NV % was reached the value as shown in Table 1, the reactor was cooled to 25° C. The insoluble catalyst was filtered through a 10-50 micron filter and was transferred in to a 5 L reactor. Methacrylic acid (MAc) or acrylic acid, tetramethyl ammonium chloride or ethyl triphenyl phosphonium acetate (ETPPA) were then introduced in the reactor in a weight ration as shown in table 1. The reactor was heated to 107° C. under purging with O₂ and a N₂ blanket with a constant agitation. Heating was continued for 5-7 h when acid number of the reaction mixture dropped from 36-38 to 5-8. Reactor was cooled to 25° C. and used this as thermoset resin material. In case of examples 1-3, GMA was added in the reactor at the beginning of the reaction while for examples 4-9, GMA was added portion wise during entire reaction.

TABLE 1

| | Styrene | GMA | EtCl | CuCl | Polycat | MAc | TMACl | ETPPA | | Mn | Visc. |
|---|---|---|---|---|---|---|---|---|---|---|---|
| Examples | Wt % | Wt % | Wt % | Wt % | Wt % | Wt % | ppm | ppm | NV % | (PD1) | Cps. |
| 1 | 87.4 | 9.7 | 2.5 | 0.17 | 0.28 | | | | 45 | 2830 | 100 |
| | | | | | | | | | | (2.2) | |
| 2 | 87.3 | 9.7 | 2.5 | 0.17 | 0.28 | | | | 68 | 4760 | 1000^{a} |
| | | | | | | | | | | (2.1) | |
| 3 | 80.7 | 8.9 | 2.7 | 0.19 | 0.34 | 7.05 | 1000 | | 52.2 | 3260 | 260 |
| | | | | | | | | | | (2.1) | |
| 4 | 81.7 | 9.0 | 2.7 | 0.098 | 0.17 | 6.25 | 1000 | | 66 | 4240 | 1000^{a} |
| | | | | | | | | | | (2.1) | |
| 5 | 82 | 9.1 | 2.7 | 0.036 | 0.063 | 6.01 | 1000 | | 69 | 6070 | 266^{a} |
| | | | | | | | | | | (2.1) | |
| 6 | 81.7 | 9.0 | 2.7 | 0.036 | 0.072 | 6.35 | 1000 | | 66 | 4700 | 1650^{a} |
| | | | | | | | | | | (2.1) | |
| 7 | 81.7 | 9.0 | 2.7 | 0.036 | 0.113 | 7.08 | 1000 | | 50 | 6360 | 290 |
| | | | | | | | | | | (2.0) | |
| 8 | 81.7 | 9.0 | 2.7 | 0.036 | 0.072 | 6.35 | 2000 | | 55 | 3587 | 600 |
| | | | | | | | | | | (2.1) | |
| 9 | 83.99 | 9.33 | 1.39 | 0.037 | 0.051 | 5.18 | | 500 | 58 | 6100 | 850 |
| | | | | | | | | | | (2.2) | |

EtCl: Ethyl-2-chloro propionate
EtBr: Ethyl-2-bromo propionate
Polycat: Pentamethyldiethylenetriamine
^{a}Viscosities are reported at 60% NV.

### Example 10

Example 10 is a blend of example 8 (80 wt %) and commercial unsaturated polyester Polylite@ (31051-00) (20 wt %).

### Example 11

Example 11 is a blend of example 8 (20 wt %), Divinyl Benzene (DVB) (10 wt %) and Polylite@(31051-00) (70 wt %).

### Example 13

Example 13 is a blend of example 8 (30 wt %) and Polylite@(31051-00) (70 wt %).

### Example 14

Example 14 is a blend of example 8 (50 wt %) and Polylite@(31051-00) (50 wt %).

### Example 12

Example 12 is a blend of example 14 (95 wt %) and Polystyrene (Mn: 75000, PDI:1.45) (5 wt %).

### Example 15

Example 15 is a laminate which contain 23.78 wt % of glass and 76.22 wt % of resin which is a blend of example 8 (63 wt %), Polylite@ (31051-00) (20 wt %) and DVB (17 wt %).

### Example 16

Example 16 is a blend of example 8 (90 wt %) and Polylite @ (31051-00) (10 wt %).
100 g resin (example 10-16) was combined with 12% Cobalt Hex-Cem (0.1 g, product of OMG), dimethyl aniline (0.1 g) and a methyl ethyl ketone peroxide (1 g of Norox 46709).
Their curing parameters were listed in Table 2.
The castings were cured for 2 h at 82° C. and 2 h at 121° C.

The properties of cured resin are listed in Tables 3-6.

TABLE 2

| | Gel time | Peak Exotherm |
|---|---|---|
| Examples | min | ° F. |
| 10 | 9.0 | 189.0 |
| 11 | 19 | 183.0 |
| 13 | 16.4 | 222.0 |
| 14 | 14 | 262.0 |
| 16 | 16.5 | 114.0 |

TABLE 3

| | | | Brookfield | Water | | | Flex | Flex |
|---|---|---|---|---|---|---|---|---|
| | Barcol | NV | #4 at 25° C. | aborption | HDT | Specific | (max. load) | (modulus) |
| Examples | Hardness | Wt % | # 60 rpm | Wt % gain | ° C. | gravity | psi | kpsi |
| 10 | 35-38 | 59 | 730 | 0.11, 24 h | 95 | 1.11 | 15690 | 674 |
| | | | | @ rt | | | | |
| 11 | 40-43 | 53 | 270 | 0.11, 24 h | 99 | 1.10 | 13064 | 595 |
| | | | | @ rt | | | | |
| 12 | 36-40 | 60 | 296 | 0.14, 24 h | 91 | | 8460 | 625 |
| | | | | @ rt | | | | |
| 13 | 39-41 | 61 | 720 | 0.13, 24 h | 93 | 1.12 | 13136 | 599 |
| | | | | @ rt | | | | |
| 14 | 42-44 | 60 | 420 | 0.17, 24 h | 91 | 1.14 | 13900 | 607 |
| | | | | @ rt | | | | |
| 15 | 47-50 | | | | | | 21,950 | 950 |

TABLE 4

| | | | | | | Izod | Izod |
|---|---|---|---|---|---|---|---|
| | Tensile | Tensile | Elong. | Comp. | Comp. | impact | impact |
| | (max. load) | (modulus) | at | (max. load) | (modulus) | (A) | (E) |
| Examples | psi | kpsi | break | psi | kpsi | Ft-lb/in | Ft-lb/in |
| 10 | 6767 | 623 | 1.42 | 16,895 | 368 | 0.18 | 2.33 |
| 11 | 6424 | 600 | 1.38 | 16,967 | 369 | 0.19 | 2.28 |
| 12 | 5091 | 651 | 1.10 | 17,810 | 388 | 0.21 | 1.67 |
| 13 | 7510 | 576 | 1.61 | 17,285 | 374 | 0.22 | 3.05 |
| 14 | 6780 | 561 | 1.45 | 17,966 | 378 | 0.26 | 2.80 |

TABLE 5

| | Tg | Tg | |
|---|---|---|---|
| | (° C.) | (° C.) | Temp.(° C.) |
| Examples | First heat | Second heat | (5 wt % loss) |
| 10 | 105 | 114 | 293 |
| 11 | 107 | 117 | 294 |
| 13 | 101 | 113 | 288 |
| 14 | 98 | 110 | 272 |

TABLE 6

| | | Linear | Linear |
|---|---|---|---|
| | Linear | shrinkage % | shrinkage % |
| Examples | shrinkage % | With 2.5% Pst^{a} | With 2.5% Pst^{a} |
| 16 | 0.32 | | |
| 11 | 0.58 | | |
| 13 | 0.99 | 0.46 | |
| 14 | 1.34 | 1.28 | 0.57 |

^{a}Pst; Polystyrene, Mn = 75,000, Mw/Mn = 1.45

TABLE 7
Linear Shrinkage Studies with Reactive Polystyrene.

| | | | % | | | | | | | | | |
|---|---|---|---|---|---|---|---|---|---|---|---|---|
| | | % | Example | | | Phase | | % | | RTG | TTP | Exo |
| Example# | Resin | Resin | #9 | % LPS | % Compatibilizer | Separation | Initiator | Initiator | % Shrink | min. | min. | ° C. |
| 17 | 33000-00 | 100 | 0 | 0 | — | — | 9-H | 1.25 | 2.05 | — | — | — |
| 18 | 33000-00 | 50 | 50 | 0 | 1.0 | No | DDM-9 | 1.25 | 0.82 | 8.7 | 16.8 | 236 |
| 19 | 33000-00 | 30 | 70 | 0 | 1.0 | No | DDM-9 | 1.25 | 0.55 | 9.1 | 17.7 | 261 |
| 20 | 33420-00 | 100 | 0 | 0 | — | No | 46709 | 1.25 | 1.92 | 7.1 | 17.1 | 386 |
| 21 | 33420-00 | 65 | 0 | 35 | 1.0 | No | 46709 | 1.25 | 1.79 | 7.2 | 22.2 | 315 |
| 22 | 33420-00 | 50 | 50 | 0 | 1.0 | No | 46709 | 1.25 | 0.99 | 2.8 | 14.5 | 310 |
| 23 | 33420-00 | 30 | 70 | 0 | 1.0 | No | 46709 | 1.25 | 0.47 | 3.9 | 16.8 | 310 |
| 24 | 33420-00 | 50 | 50 | 0 | 1.0 | No | 46709 | 1.25 | 0.54 | 4.2 | 17.2 | 310 |
| 25 | 33375-30 | 100 | 0 | 0 | — | No | Trig239 | 2.00 | 1.19 | 7.0 | 12.4 | 353 |
| 26 | 33375-30 | 50 | 50 | 0 | 1.0 | No | Trig239 | 2.00 | 0.53 | 8.0 | 15.3 | 178 |
| 27 | 33375-30 | 30 | 70 | 0 | 1.0 | No | Trig239 | 2.00 | 0.54 | 8.5 | 18.0 | 165 |

33000-00 is a PG/PET/Maleate
33420-00 is a PG/Iso/Maleate and was promoted with 0.15-0.2 12% Cobalt, 0.05 DMA, and adjusted with HQ to reasonable gel time.
Hydrex 100HF (33375-30) is a vinyl ester resin and was promoted with 0.3 12% Cobalt and 0.15 DMA.
LPS—Standard Linear Polystyrene.
Norox MEKPO-9-H - is a peroxide from Norak Inc.
Norox 46709 - is a MEKPO peroxide from Norak, Inc.
Superox DDM-9 - is a MEKPO peroxide from Atofina, Co.
Trigonox 239 - is a peroxide from Akzo Chemie.

### Examples 28 and 29 Via Two Stage Reaction

A 10 gallon seven-necked steel reactor equipped with a mechanical agitator, a reflux condenser, a N₂ inlet, an internal cooling coil, and a temperature controlling mechanism was purged thoroughly with N₂ for a period of 5-10 min. 29832 Grams of styrene, 3337 grams of glycidyl methacrylate (GMA), 546 grams of ethyl 2-chloropropionate (ECP), 13.27 grams of CuCl, and 17.9 grams of Polycat 5 (Pentamethyldiethylenetriamine) were introduced in the reactor.

The reaction mixture was purged with N₂ for 20 minutes minimum while heating was initiated. When the temperature reached 70° C., N₂ purging was stopped and a N₂ blanket was maintained thereafter during the entire reaction. The reactor was then brought to 107° C. with constant agitation. Samples were withdrawn under N₂ at the top heat and every hour thereafter and % NV was determined gravimetrically. When the NV reached a value of 54%, the reactor was cooled to 32° C. maximum. The insoluble catalyst was filtered through a 50M bag filter and 21999 grams of the intermediate (Example 28) was transferred back into the 10 gallon reactor. 1115 Grams of acrylic acid, 26 grams of a 80% ethyltriphenylphosphonium acid acetate (ETPPAA) solution, and 7 grams of THQ were then introduced in the reactor. The reactor was heated to 90° C. with an air sparge and a N₂ blanket with a constant agitation. The temperature was maintained for 5-7 hours until the acid number of the reaction mixture dropped from 34-38 to 12. The reactor was cooled to 32° C. maximum and the material filtered through a 50M bag filter. This material is the thermosetting reactive polystyrene (Example 29).

### Examples 30 and 31 Via Three Stage Reaction

A 10 gallon seven-necked steel reactor equipped with a mechanical agitator, a reflux condenser, a N₂ inlet, an internal cooling coil, and a temperature controlling mechanism was purged thoroughly with N₂ for a period of 5-10 min. 29835 Grams of styrene, 2237 grams of glycidyl methacrylate (GMA), 546 grams of ethyl 2-chloropropionate (ECP), 13.27 grams of CuCl, and 17.9 grams of Polycat 5 (Pentamethyldiethylenetriamine) were introduced in the reactor.

The reaction mixture was purged with N₂ for 20 minutes minimum while heating was initiated. When the temperature reached 70° C., N₂ purging was stopped and a N₂ blanket was maintained thereafter during the entire reaction. The reactor was then brought to 107° C. with constant agitation. Samples were withdrawn under N₂ at the top heat and every hour thereafter and % NV was determined gravimetrically. When the NV reached a value of 25%, the reactor was cooled to 100° C. maximum. 1100 Grams of glycidyl methacrylate (GMA) was introduced to the mixture in a single shot and the reactor reheated to 107° C. Samples were withdrawn under N₂ at the top heat and every hour thereafter and % NV was determined gravimetrically. When the NV reached a value of 54%, the reactor was cooled to 32° C. maximum. The insoluble catalyst was filtered through a 50M bag filter and 32470 grams of the intermediate (Example 30) was transferred back into the 10 gallon reactor. 1599 Grams of acrylic acid, 38 grams of a 70% ethyltriphenylphosphonium acid acetate (ETPPAA) solution, and 10 grams of THQ were then introduced in the reactor. The reactor was heated to 95° C. with an air sparge and a N₂ blanket with a constant agitation. The temperature was maintained for 5-7 hours until the acid number of the reaction mixture dropped to 10. The reactor was cooled to 32° C. maximum and the material filtered through a 50M bag filter. This material is the thermosetting reactive polystyrene (Example 31).

The procedure for example 30 was also used to produce examples 32-33 in Table 8-11, and the procedure for example 28 was also used to produce examples 34-37 in Tables 8-11. Examples 28 and 30 yield similar GPC analyses as well as liquid properties.

TABLE 8
Composition of functional copolymers via ATRP mediated route.

| Example | Styrene | GMA | MMA | BMA | DMAA |
|---|---|---|---|---|---|
| 28 | 91 | 9 | | | |
| 30 | 91 | 9 | | | |
| 32 | 89 | | 9 | | |
| 33 | 89 | | | 9 | |
| 34 | 90 | 5 | 5 | | |
| 35 | 90 | 2.5 | 7.5 | | |
| 36 | 90 | 5 | | 5 | |
| 37 | 90 | 5 | | | 5 |

* GMA = Glycidyl Methacrylate; MMA = Methyl Methacrylate; BMA = Butyl Methacrylate; DMAA = Dimethyl acrylamide.

TABLE 9
Functional copolymers via ATRP mediated route, liquid properties.

| | | | | | | Rxn |
|---|---|---|---|---|---|---|
| Example | MCP/ECP | % NV | Visc. | Mn | Mw | Time (hr) |
| 28 | 1.6 | 54.0 | NR | 7971 | 16394 | 10 |
| 30 | 1.5 | 57.2 | 900 | 4590 | 15600 | 8 |
| 32 | 1.5 | 47.8 | 184 | 3085 | 13646 | 18 |
| 33 | 1.5 | 24.9 | NR | 1300 | 10712 | 9 |
| 34 | 1.6 | 43.7 | NR | 3416 | 22772 | 20 |
| 35 | 1.6 | 28.8 | NR | 2318 | 21471 | 22 |
| 36 | 1.6 | 38.2 | 87 | 10965 | 24336 | 15 |
| 37 | 1.6 | 51.5 | 580 | 7519 | 15973 | 11 |

* MCP = methyl chloropropionate; ECP = ethyl chloropropionate.

TABLE 10
Linear Shrinkage for Non-filled Blends Made From
Functional Copolystyrenes

| | | | Additional | | |
|---|---|---|---|---|---|
| Exam- | Resin 1 | | Styrene | % Linear | Average |
| ple | (pph) | Resin 2 (pph) | pph | Shrinkage* | Barcol* |
| 38 | — | 31051-00 (100) | 0 | 1.62 | NR |
| 39 | 30 (30) | 31051-00 (70) | 0 | 1.44 | NR |
| 40 | 30 (40) | 31051-00 (60) | 0 | 1.49 | NR |
| 41 | 30 (50) | 31051-00 (50) | 0 | 1.30 | NR |
| 42 | 30 (47) | 31051-00 (47) | 6 | 1.40 | 27 |
| 43 | 30 (47) | 31453-00 (47) | 6 | 1.32 | 28 |
| 44 | 30 (44) | 31051-00 (44) | 12 | 0.77 | 24 |
| 45 | 30 (44) | 31453-00 (44) | 12 | 1.13 | 20 |
| 46 | 34 (50) | 31051-00 (50) | 0 | 1.58 | 26 |
| 47 | 36 (50) | 31051-00 (50) | 0 | 1.63 | 26 |

*Typical conditions for examples 38-47: Blend resins in ratio stated with respect to resin 1, resin 2, and styrene. Promote blend with 0.2 pph 12% Cobalt Octoate, 0.1 pph DMA, and 50 ppm MTBHQ. Initiate with 1.25 pph MEKP 46-709 and pour into shrink bar. After 2 hours at 25° C., post-cure 1 hour at 60° C. and 2 hours at 120° C. Cool overnight and measure linear shrinkage and barcol.
NR = not recorded.

TABLE 11
Linear Shrinkage for Filled Blends Made From Functional Copolystyrenes

| | Resin 1 | Resin 2 | Additional | Filler Type | % Linear | Average |
|---|---|---|---|---|---|---|
| Example | (pph) | (pph) | Styrene pph | (pph) | Shrinkage* | Barcol* |
| 48 | 30 (31) | 31051 (31) | 5 | CaCO₃ (33) | 0.543 | 39 |
| 49 | 30 (29) | 31051 (29) | 8 | CaCO₃ (33) | 0.441 | 22 |
| 50 | 30 (31) | 31051 (31) | 5 | ATH (33) | 0.524 | 36 |
| 51 | 30 (29) | 31453 (29) | 8 | ATH (33) | 0.705 | 43 |
| 52 | 30 (29) | 31453 (29) | 8 | CaCO₃ (33) | 0.677 | 39 |
| 53 | 30 (36) | 31051 (15) | 4 | CaCO₃ (45) | 0.445 | 42 |
| 54 | 30 (24) | 31051 (24) | 7 | CaCO₃ (45) | 0.634 | 39 |
| 55 | 30 (43) | 31051 (19) | 5 | CaCO₃ (33) | 0.358 | 26 |
| 56 | 30 (24) | 31051 (24) | 7 | ATH (45) | 0.764 | 27 |
| 57 | 30 (24) | 31453 (24) | 7 | CaCO₃ (45) | 0.709 | 24 |
| 58 | 30 (43) | 31453 (19) | 5 | CaCO₃ (33) | 0.445 | 21 |
| 59 | 30 (43) | 31051 (19) | 5 | ATH (33) | 0.283 | 29 |
| 60 | 30 (36) | 31051 (15) | 4 | ATH (45) | 0.512 | 34 |
| 61 | 30 (36) | 31453 (15) | 4 | CaCO₃ (45) | 0.315 | 24 |

*Typical conditions for examples 48-61: Blend resin 1, resin 2 and styrene in specified ratios. Promote blend with 0.2 pph 12% Cobalt Octoate, 0.1 pph DMA, and 50 ppm MTBHQ, then add appropriate filler ratio. Initiate with 1.25 pph MEKP 46-709 and pour into shrink bar. After 2 hours at 25° C., post-cure 1 hour at 60° C. and 2 hours at 120° C. Cool overnight and measure linear shrinkage and barcol.

TABLE 12
Linear Shrinkage for Non-filled Blends Made From
Reactive Copolystyrene 31

| | | | % Linear |
|---|---|---|---|
| Example | Resin 1 (pph) | Resin 2 (pph) | Shrinkage* |
| 38 | — | 31051-00 (100) | 1.62 |
| 62 | 31 (86.5) | 31051-00 (13.5) | 0.98 |
| 63 | 31 (80) | 31051-00 (20) | 1.05 |
| 64 | 31 (65) | 31051-00 (35) | 1.33 |
| 65 | 31 (50) | 31051-00 (50) | 1.68 |

*Typical conditions for examples 38, 62-65: Blend resins in ratio stated with respect to resin 1 and resin 2, and styrene. Promote blend with 0.2 pph 12% Cobalt Octoate, 0.1 pph DMA, and 50 ppm MTBHQ. Initiate with 1.25 pph MEKP 46-709 and pour into shrink bar. After 2 hours at 25° C., post-cure 1 hour at 60° C. and 2 hours at 120° C. Cool overnight and measure linear shrinkage and barcol.

TABLE 13
Linear Shrinkage for Filled Blends Made From Reactive Copolystyrene 31

| | Resin 1 | Resin 2 | Additional | Filler Type | % Linear | Average |
|---|---|---|---|---|---|---|
| Example | (pph) | (pph) | Styrene pph | (pph) | Shrinkage* | Barcol* |
| 66 | 31 (31) | 31051 (31) | 5 | CaCO₃ (33) | 0.791 | 49 |
| 67 | 31 (29) | 31051 (29) | 8 | CaCO₃ (33) | 0.937 | 44 |
| 68 | 31 (31) | 31051 (31) | 5 | ATH (33) | 0.780 | 46 |
| 69 | 31 (29) | 31453 (29) | 8 | ATH (33) | 0.965 | 50 |
| 70 | 31 (29) | 31453 (29) | 8 | CaCO₃ (33) | 1.193 | 41 |
| 71 | 31 (36) | 31051 (15) | 4 | CaCO₃ (45) | 0.799 | 41 |
| 72 | 31 (24) | 31051 (24) | 7 | CaCO₃ (45) | 0.713 | 30 |
| 73 | 31 (43) | 31051 (19) | 5 | CaCO₃ (33) | 0.949 | 40 |
| 74 | 31 (24) | 31051 (24) | 7 | ATH (45) | 0.851 | 50 |
| 75 | 31 (24) | 31453 (24) | 7 | CaCO₃ (45) | 0.118 | 43 |
| 76 | 31 (43) | 31453 (19) | 5 | CaCO₃ (33) | 0.693 | 36 |
| 77 | 31 (43) | 31051 (19) | 5 | ATH (33) | 0.976 | 43 |
| 78 | 31 (36) | 31051 (15) | 4 | ATH (45) | 0.390 | 45 |
| 79 | 31 (36) | 31453 (15) | 4 | CaCO₃ (45) | 0.634 | 44 |

*Typical conditions for examples 66-79: Blend resin 1, resin 2 and styrene in specified ratios. Promote blend with 0.2 pph 12% Cobalt Octoate, 0.1 pph DMA, and 50 ppm MTBHQ, then add appropriate filler ratio. Initiate with 1.25 pph MEKP 46-709 and pour into shrink bar. After 2 hours at 25° C., post-cure 1 hour at 60° C. and 2 hours at 120° C. Cool overnight and measure linear shrinkage and barcol.

The invention has been described in detail with reference to its preferred embodiments and its examples. However, it will be apparent that numerous variations and modifications can be made without departure from the spirit and scope of the invention as described in the foregoing specifications and claims.

What is claimed:

1. A crosslinkable polymer system comprising
(a) a product Q formed from an aromatic ethylenically unsaturated moiety and a first reactive ethylenically unsaturated moiety wherein product Q provides carbon-carbon linkages in the backbone of said crosslinkable polymer system, and
(b) a second reactive ethylenically unsaturated moiety at least partially reacted with said first reactive ethylenically unsaturated moiety of product Q.

2. The crosslinkable polymer system according to claim 1, wherein the aromatic ethylenically unsaturated monomer is selected from the group consisting of styrene and derivatives thereof, 2-vinyl pyridine, 6-vinyl pyridine, 2-vinyl pyrrole, 2-vinyl pyrrole, 5-vinyl pyrrole, 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxozole, 3-vinyl isothiazole, 2-vinyl pyrimidine, 4-vinyl pyrimidine, 6-vinyl pyrimidine, and vinyl pyrazines.

3. The crosslinkable polymer system according to claim 1, wherein the first reactive ethylenically unsaturated monomer has the formula 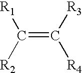
wherein R₁, R₂, R₃ and R₄ are independently selected from the group consisting of H, halogen, CN, straight or branched alkyl having 1 to 20 carbon atoms, halogen-substituted straight or branched alkyl having 1 to 20 carbon atoms, β-unsubstituted straight or branched alkenyl having 2 to 10 carbon atoms, -straight or branched alkenyl having 2 to 10 carbon atoms, unsubstituted straight or branched alkynyl having 2 to 10 carbon atoms, C₃ to C₈ cycloalkyl, amines, substituted phosphorus, sylyl, siloxy, epoxy, isocyanate, and hydroxyl,

4. The crosslinkable polymer system according to claim 1, wherein the second reactive ethylenically unsaturated moiety is selected from the group consisting of (meth)acrylates, polyfunctional acrylates, vinyl aromatics, heterocyclyls vinyl halides, vinyl esters of carboxylic acids, and methyl(allylic) monomers.

5. The crosslinkable polymer system of claim 1, further comprising a polymerization initiator having one or more atoms or atomic groups that are radically transferable.

6. The crosslinkable polymer system of claim 1, further comprising a transition metal catalyst.

7. The crosslinkable polymer system of claim 6, wherein said transition metal catalyst includes a polymerization ligand.

8. The crosslinkable polymer system of claim 1, further comprising a polymerization inhibitor.

9. The crosslinkable polymer system of claim 1, further comprising a chain transfer agent.

10. The crosslinkable polymer system of claim 1, further comprising one or more additives selected from the group consisting of fiber reinforcement, antioxidants, fillers, thickening agents, flow agents, lubricants, air release agents, wetting agents, UV stabilizers, compatibilizers and shrink-reducing additives.

11. The crosslinkable polymer system of claim 1, wherein the polymer is crosslinked with an organic peroxide.

12. The crosslinkable polymer system of claim 1, wherein the mixture of (a) and (b) includes a curing accelerator.

13. The crosslinkable polymer system of claim 1, wherein the polymer is crosslinked with a radiation curing initiator.

14. A crosslinkable polymer system comprising
(a) a product Q formed from an aromatic ethylenically unsaturated moiety and a reactive ethylenically unsaturated moiety, said product Q providing carbon-carbon linkages in the backbone of said crosslinkable system, and
(b) a thermosettable moiety, a thermoplastic moiety or a monomer wherein said product Q and said thermosettable moiety, thermoplastic moiety or monomer is crosslinkable with said reactive ethylenically unsaturated moiety of product Q.

15. The crosslinkable polymer system according to claim 14 wherein the aromatic ethylenically unsaturated monomer is selected from the group consisting of styrene and derivatives thereof, 2-vinyl pyridine, 6-vinyl pyridine, 2-vinyl pyrrole, 2-vinyl pyrrole, 5-vinyl pyrrole, 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxozole, 3-vinyl isothiazole, 2-vinyl pyrimidine, 4-vinyl pyrimidine, 6-vinyl pyrimidine, and vinyl pyrazines.

16. The crosslinkable polymer system according to claim 14, wherein the first reactive ethylenically unsaturated monomer has the formula 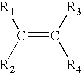
wherein R₁, R₂, R₃ and R₄ are independently selected from the group consisting of H, halogen, CN, straight or branched alkyl having 1 to 20 carbon atoms, halogen-substituted straight or branched alkyl having 1 to 20 carbon atoms, β-unsubstituted straight or branched alkenyl having 2 to 10 carbon atoms, halogen-substituted, -straight or branched alkenyl having 2 to 10 carbon atoms, unsubstituted straight or branched alkynyl having 2 to 10 carbon atoms, halogen-substituted straight or branched aklynyl having 2 to 10 carbon atoms, C₃ to C₈ cycloalkyl, amines, substituted phosphorus, sylyl, siloxy, epoxy, isocyanate, and hydroxyl.

17. The crosslinkable polymer system according to claim 14, wherein the second reactive ethylenically unsaturated moiety is selected from the group consisting of (meth)acrylates, polyfunctional acrylates, vinyl aromatics, heterocyclyls vinyl halides, vinyl esters of carboxylic acids, and methyl(allylic) monomers.

18. The crosslinkable polymer system of claim 14, further comprising a polymerization initiator having one or more atoms or atomic groups that are radically transferable.

19. The crosslinkable polymer system of claim 14, further comprising a transition metal catalyst.

20. The crosslinkable polymer system of claim 19, wherein said transition metal catalyst includes a polymerization ligand.

21. The crosslinkable polymer system of claim 14, further comprising a polymerization inhibitor.

22. The crosslinkable polymer system of claim 14, further comprising a chain transfer agent.

23. The crosslinkable polymer system of claim 14, further comprising one or more additives selected from the group consisting of fiber reinforcement, antioxidants, fillers, thickening agents, flow agents, lubricants, air release agents, wetting agents, UV stabilizers, compatibilizers and shrink-reducing additives.

24. The crosslinkable polymer system of claim 14, wherein the thermosetting moiety is selected from the group consisting of unsaturated polyesters, vinyl esters, polyurethane acrylates, isocyanurate acrylates, polyamide ester acrylates and polyurethanes.

25. The crosslinkable polymer system of claim 14, wherein the thermoplastic moiety is selected from the group consisting of styrene-based polymers, polyethylene, polyvinyl acetate-based polymers, polyvinyl chloride polymers, polyurethanes, ABS copolymers, polyethyl methacrylates, polymethyl methacrylates, polycaprolactone, butadiene-styrene copolymer, saturated polyesters, vinyl chloride/vinyl acetate copolymer, vinyl acetate/acrylic acid copolymer, vinyl acetate/methacrylic acid copolymer, styrene/acrylonitrile copolymer, styrene acrylic acid/allylacrylate copolymer, styrene acrylic acid/allyl methacrylate copolymer, methyl methacrylate/alkyl ester of acrylic acid copolymer, methyl methacrylate/styrene copolymer, and methyl methacrylate/acrylamide copolymer, epoxy intermediates, fatty acid intermediates, isocyanate containing intermediates, and polyurethanes.

26. The crosslinkable polymer system of claim 14 further comprising one or more additives selected from the group consisting of fiber reinforcement, antioxidants, fillers, thickening agents, flow agents, lubricants, air release agents, wetting agents, UV stabilizers, compatibilizers and shrink-reducing additives.

27. The crosslinkable polymer system of claim 14, wherein the polymer is crosslinked with an organic peroxide.

28. The crosslinkable polymer system of claim 14, wherein the mixture of (a) and (b) includes a curing accelerator.

29. The crosslinkable polymer system of claim 14, wherein the polymer is crosslinked with a radiation curing initiator.

30. A crosslinkable polymer system comprising
(a) a product Q formed from an aromatic ethylenically unsaturated moiety and a first reactive ethylenically unsaturated moiety wherein product Q provides carbon-carbon linkages in the backbone of said crosslinkable polymer system,
(b) a second reactive ethylenically unsaturated moiety at least partially reacted with said first reactive ethylenically unsaturated moiety of product Q, and
(c) a thermosettable moiety, a thermoplastic moiety or a monomer wherein said thermosettable moiety, thermoplastic moiety or monomer is crosslinkable with said first or second reactive ethylenically unsaturated moiety or both.

31. The crosslinkable polymer system according to claim 30, wherein the aromatic ethylenically unsaturated monomer is selected from the group consisting of styrene and derivatives thereof, 2-vinyl pyridine, 6-vinyl pyridine, 2-vinyl pyrrole, 2-vinyl pyrrole, 5-vinyl pyrrole, 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxozole, 3-vinyl isothiazole, 2-vinyl pyrimidine, 4-vinyl pyrimidine, 6-vinyl pyrimidine, and vinyl pyrazines.

32. The crosslinkable polymer system according to claim 27, wherein the first reactive ethylenically unsaturated monomer has the formula 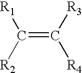
wherein R₁, R₂, R₃ and R₄ are independently selected from the group consisting of H, halogen, CN, straight or branched alkyl having 1 to 20 carbon atoms, halogen-substituted straight or branched alkyl having 1 to 20 carbon atoms, β-unsubstituted straight or branched alkenyl having 2 to 10 carbon atoms, halogen-substituted, -straight or branched alkenyl having 2 to 10 carbon atoms, unsubstituted straight or branched alkynyl having 2 to 10 carbon atoms, halogen-substituted straight or branched aklynyl having 2 to 10 carbon atoms, C₃ to C₈ cycloalkyl, heterocyclyl, meth(acrylates), vinyl aromatics, vinyl halides, vinyl esters of carboxylic acids, polyfunctional acrylates, and (meth)allylic monomers.

33. The crosslinkable polymer system according to claim 32, wherein the second reactive ethylenically unsaturated moiety is selected from the group consisting of (meth)acrylates, polyfunctional acrylates, vinyl aromatics, heterocyclyls, vinyl halides, vinyl esters of carboxylic acids, and methyl(allylic) monomers.

34. The crosslinkable polymer system of claim 32, further comprising a polymerization initiator having one or more atoms or atomic groups that are radically transferable.

35. The crosslinkable polymer system of claim 32, further comprising a transition metal catalyst.

36. The crosslinkable polymer system of claim 35, wherein said transition metal catalyst includes a polymerization ligand.

37. The crosslinkable polymer system of claim 35, further comprising a polymerization inhibitor.

38. The crosslinkable polymer system of claim 35, further comprising a chain transfer agent.

39. The crosslinkable polymer system of claim 32, wherein the thermosetting moiety is selected from the group consisting of unsaturated polyesters, saturated polyesters, vinyl esters, polyurethane acrylates, isocyanurate acrylates, polyamide ester acrylates and polyurethanes,

40. The crosslinkable polymer system of claim 32, wherein the thermoplastic moiety is selected from the group consisting of styrene-based polymers, polyethylene, polyvinyl acetate-based polymers, polyvinyl chloride polymers, polyurethanes, ABS copolymers, polyethyl methorcrylates, polymethyl methacrylates, polycaprolactone, butadiene-styrene copolymer saturated polyesters, vinyl chloride/vinyl acetate copolymer, vinyl acetate/acrylic acid copolymer, vinyl acetate/methacrylic acid copolymer, styrene/acrylonitrile copolymer, styrene acrylic acid/allylacrylate copolymer, styrene acrylic acid/allyl methacrylate, methyl methacrylate/alkyl ester of acrylic acid copolymer, methyl methacrylate/styrene copolymer, and methyl methacrylate/acrylamide copolymer.

41. The crosslinkable polymer system of claim 32 further comprising one or more additives selected from the group consisting of fiber reinforcement, antioxidants, fillers, thickening agents, flow agents, lubricants, air release agents, wetting agents, UV stabilizers, compatibilizers and shrink-reducing additives.

42. The crosslinkable polymer system of claim 32, wherein the polymer is crosslinked with an organic peroxide.

43. The crosslinkable polymer system of claim 32, wherein the system includes a curing accelerator.

44. The crosslinkable polymer system of claim 32, wherein the polymer is crosslinked with a radiation curing initiator.

45. A method of making a crosslinkable polymer system having carbon-carbon linkages in its backbone, the method comprising the steps of:
(a) forming a product Q by reacting an aromatic ethylenically unsaturated monomer and a first reactive ethylenically unsaturated monomer with a second reactive ethylenically unsaturated monomer, and
(b) reacting at least partially the product Q of step (a) through the second reactive ethylenically unsaturated monomer to provide with carbon-carbon linkages in the backbone of the crosslinkable polymer system.

46. The method according to claim 45, wherein the step of crosslinking occurs in the range of −20° to 200° C.

47. A method of making a crosslinkable polymer system having carbon-carbon linkages in its backbone, the method comprising the steps of:
(a) forming a product Q by reacting an aromatic ethylenically unsaturated monomer and a reactive ethylenically unsaturated monomer; and
(b) reacting the product Q of step (a) with a thermosettable moiety, a thermoplastic moiety or a monomer crosslinkable with the reactive ethylenically unsaturated monomer.
